(19) United States
(12) Patent Application Publication
(10) Pub. No.: US 2026/0156546 A1
(43) Pub. Date: Jun. 4, 2026

(54) FEEDBACK ON PREDICTED USER EQUIPMENT TRAJECTORY

(71) Applicant: Telefonaktiebolaget LM Ericsson (PUBL), Stockholm (SE)

(72) Inventors: Luca LUNARDI, Genova (IT); Germán BASSI, Årsta (SE); Ioanna PAPPA, Stockholm (SE); Vengatanathan KRISHNAMOORTHI, Linköping (SE); Julien MULLER, Rennes (FR); Angelo CENTONZA, Granada (ES)

(21) Appl. No.: 19/126,710

(22) PCT Filed: Nov. 3, 2023
(86) PCT No.: PCT/EP2023/080630

§ 371 Date: May 2, 2025

(30) Foreign Application Priority Data
Nov. 3, 2022 (GR) 20220100893

(51) Int. Cl. H04W 72/23

(52) U.S. Cl. CPC H04W 36/008375; H04W 4/029; H04W 36/324; H04W 64/006

(57) ABSTRACT

The disclosure refers to a method performed by a first network node, the method comprising: obtaining (1101) a user equipment, UE, trajectory prediction, transmitting (1102) the UE trajectory prediction to a second network node along with an indication requesting feedback regarding the UE trajectory prediction, and receiving (1103) feedback regarding the UE trajectory prediction from a third network node, and to a method performed by a second network node, the method comprising: receiving (1201) a UE trajectory prediction along with an indication requesting feedback regarding the UE trajectory prediction, and transmitting (1202) feedback regarding the UE trajectory prediction to a first network node.

### TECHNICAL FIELD

Embodiments of the present disclosure are directed to wireless communications and, more particularly, to feedback on predicted user equipment (UE) trajectory.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The next generation radio access network (NG-RAN) consists of a set of gNBs connected to the fifth generation core (5GC) through the NG interface. An example is illustrated in FIG. 1.

FIG. 1 is a block diagram illustrating the NG-RAN architecture, as described in Technical Specification (TS) 38.401 (e.g. v17.2.0). As specified in TS 38.300 (e.g. v17.2.0), the NG-RAN may also consist of a set of ng-eNBs. An ng-eNB may consist of an ng-eNB central unit (CU) and one or more ng-eNB distributed units (DU(s)). An ng-eNB-CU and an ng-eNB-DU ARE connected via the W1 interface. The general principle described herein also applies to ng-eNB and the W1 interface, if not explicitly specified otherwise.

An gNB can support frequency division duplex (FDD) mode, time division duplex (TDD) mode or dual mode operation. The gNBs may be interconnected through the Xn interface. A gNB may consist of a gNB-CU and one or more gNB-DU(s). A gNB-CU and a gNB-DU are connected via the F1 interface. One gNB-DU is connected to only one gNB-CU.

For network sharing with multiple cell identity broadcast, each cell identity associated with a subset of public land mobile networks (PLMNs) corresponds to a gNB-DU and the gNB-CU it is connected to, i.e., the corresponding gNB-DUs share the same physical layer cell resources.

For resiliency, a gNB-DU may be connected to multiple gNB-CUs by appropriate implementation.

The NG, Xn and F1 are logical interfaces.

For NG-RAN, the NG and Xn-C interfaces for a gNB consisting of a gNB-CU and gNB-DUs terminate in the gNB-CU. For EN-DC, the S1-U and X2-C interfaces for a gNB consisting of a gNB-CU and gNB-DUs terminate in the gNB-CU. The gNB-CU and connected gNB-DUs are only visible to other gNBs and the 5GC as a gNB.

The node hosting the user plane part of New Radio (NR) Packet Data Convergence Protocol (PDCP) (e.g., gNB-CU, gNB-CU-UP, and for EN-DC, MeNB or SgNB depending on the bearer split) shall perform user inactivity monitoring and further informs its inactivity or (re) activation to the node having C-plane connection towards the core network (e.g., over E1, X2). The node hosting NR Radio Link Control (RLC) (e.g., gNB-DU) may perform user inactivity monitoring and further inform its inactivity or (re) activation to the node hosting control plane, e.g., gNB-CU or gNB-CU-CP.

Uplink (UL) PDCP configuration (i.e., how the UE uses the UL at the assisting node) is indicated via X2-C (for EN-DC), Xn-C (for NG-RAN) and F1-C. Radio Link Outage/Resume for downlink (DL) and/or UL is indicated via X2-U (for EN-DC), Xn-U (for NG-RAN) and F1-U.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1), the related TNL protocol and the functionality are specified. The TNL provides services for user plane transport and signalling transport.

In NG-Flex configuration, each NG-RAN node is connected to all access and mobility management functions (AMFs) of AMF sets within an AMF region supporting at least one slice also supported by the NG-RAN node. The AMF set and the AMF region are defined in 3GPP TS 23.501 (e.g. v17.6.0).

If security protection for control plane and user plane data on TNL of NG-RAN interfaces has to be supported, network domain security (NDS)/Internet Protocol (IP) 3GPP TS 33.501 (e.g. v17.7.0) shall be applied.

The architecture for separation of gNB-CU-CP and gNB-CU-UP is depicted in FIG. 2 and specified in TS 37.483 (e.g. v17.2.0).

FIG. 2 is a block diagram illustrating the architecture for separation of gNB-CU-CP and gNB-CU-UP. A gNB may consist of a gNB-CU-CP, multiple gNB-CU-UPs and multiple gNB-DUs.

The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP.

For resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP. One gNB-CU-UP can be connected to multiple DUs under the control of the same gNB-CU-CP.

The connectivity between a gNB-CU-UP and a gNB-DU is established by the gNB-CU-CP using bearer context management functions. The gNB-CU-CP selects the appropriate gNB-CU-UP(s) for the requested services for the UE. For multiple CU-Ups, they belong to same security domain as defined in TS 33.210 (e.g. v17.1.0). Data forwarding between gNB-CU-UPs during intra-gNB-CU-CP handover within a gNB may be supported by Xn-U.

Third Generation Partnership Project (3GPP) Release 16 includes UE history information. The network node collects information on cells visited by a UE in active mode and stores it as UE history information. The information is stored as a list pertaining to each cell in chronological order with the latest information at the top of the list. In the 3GPP standard, this list is capped at 16 entries (16 cells) as the stated objective of UE history information is to prevent ping-pong. Ping-pong handover is an undesirable phenomenon in mobile networks in which a UE performs frequent handovers between the same pair of cells back and forth, in a short time period.

The UE history information that is collected at a node is transferred to the target node during handover over Xn. Similarly, it is sent to the CN over NG during context release.

The data stored is dependent on the type of the connected cell as seen in the procedural text. For a NR cell, the network node collects the global cell ID, cell type, time UE stayed in cell, and the handover cause and stores them for each UE upon cell change/handover.

The information element (IE) UE History Information from UE corresponds to the mobility history information (MHI), is defined in 3GPP TS 38.413 v17.1.0, and contains information about mobility history report for a UE. The mobility history contains the list of cell(s) the UE was connected to or was camping on. It is generated by the UE at RRC_Connected but also RRC_INACTIVE and IDLE. The content of the IE is shown below:

| | | | | |
|---|---|---|---|---|
| | | | IE type and | Semantics |
| IE/Group Name | Presence | Range | reference | description |

| | | | |
|---|---|---|---|
| CHOICE UE | M | | |
| History | | | |
| Information from | | | |
| UE | | | |
| >NR | | | |
| >>NR Mobility | M | OCTET | VisitedCellInfoList |
| History Report | | STRING | contained in the |
| | | | UEInformationResponse |
| | | | message (TS 38.331). |

The referenced VisitedCellInfoList information element (IE) is specified in 3GPP TS 38.331 v17.1.0 as follows:

VisitedCellInfoList-r16 ::= SEQUENCE (SIZE (1..maxCellHistory-r16)) OF VisitedCellInfo-r16

| VisitedCellInfo-r16 ::= | SEQUENCE { | | | | | | |
|---|---|---|---|---|---|---|---|
| visitedCellId-r16 | | CHOICE { | | | | | |
| nr-CellId-r16 | | | CHOICE { | | | | |
| cgi-Info | | | | CGI-Info-Logging-r16, | | | |
| pci-arfon-r16 | | | | PCI-ARFCN-NR-r16 | | | |
| }, | | | | | | | |
| eutra-CellId-r16 | | | CHOICE { | | | | |
| cellGlobalId-r16 | | | | CGI-InfoEUTRA, | | | |
| pci-arfon-r16 | | | | | PCI-ARFCN-EUTRA-r16 | | |
| } | | | | | | | |
| } | | | | | | OPTIONAL, | |
| timeSpent-r16 | | INTEGER (0..4095), | | | | | |
| ..., | | | | | | | |
| [[ | | | | | | | |
| visitedPSCellInfoList-r17 | | | VisitedPSCellInfoList-r17 | | | | OPTIONAL |
| ]] | | | | | | | |
| } | | | | | | | |

VisitedPSCellInfoList-r17 ::= SEQUENCE (SIZE (1..maxPSCellHistory-r17)) OF VisitedPSCellInfo-

| r17 | | | | | |
|---|---|---|---|---|---|
| VisitedPSCellInfo-r17 ::= | SEQUENCE { | | | | |
| visitedCellId-r17 | | CHOICE { | | | |
| nr-CellId-r17 | | | CHOICE { | | |
| cgi-Info-r17 | | | | CGI-Info-Logging-r16, | |
| pci-arfon-r17 | | | | PCI-ARFCN-NR-r16 | |
| }, | | | | | |
| eutra-CellId-r17 | | CHOICE { | | | |
| cellGlobalId-r17 | | | CGI-InfoEUTRALogging, | | |
| pci-arfon-r17 | | | PCI-ARFCN-EUTRA-r16 | | |
| } | | | | | |
| } | | | | | OPTIONAL, |
| timeSpent-r17 | INTEGER (0..4095), | | | | |
| ... | | | | | |
| } | | | | | |

Another mobility history is generated by the network and referred to as UE history information (UHI). It contains the list of cell(s) the UE was connected to. It is generated by the network at RRC_Connected. It is defined in TS 38.413. This IE contains information about cells that a UE has been served by in active state prior to the target cell.

| | | | IE type and | |
|---|---|---|---|---|
| IE/Group Name | Presence | Range | reference | Semantics description |
| Last Visited Cell Item | | 1 . . . | | Most recent information is |
| | | <maxnoofCellsinUEHistoryInfo> | | added to the top of this list. |
| >Last Visited Cell | M | | 9.3.1.96 | |
| Information | | | | |

| Range bound | Explanation |
|---|---|
| maxnoofCellsinUEHistoryInfo | Maximum no. of cells in the UE history |
| | information. Value is 16. |

The Last Visited Cell Information IE may contain cell specific information.

| | | | | |
|---|---|---|---|---|
| | Pres- | | IE type and | Semantics |
| IE/Group Name | ence | Range | reference | description |

| | | | |
|---|---|---|---|
| CHOICE Last Visited | M | | |
| Cell Information | | | |
| >NG-RAN Cell | | | |
| >>Last Visited NG- | M | 9.3.1.97 | |
| RAN Cell | | | |
| Information | | | |
| >E-UTRAN Cell | | | |
| >>Last Visited E- | M | OCTET | Defined in |
| UTRAN Cell | | STRING | TS 36.413, |
| Information | | | (e.g. |
| >UTRAN Cell | | | v17.2.0). |
| >>Last Visited | M | OCTET | Defined in |
| UTRAN Cell | | STRING | TS 25.413, |
| Information | | | (e.g. |
| >GERAN Cell | | | v17.0.0). |
| >>Last Visited | M | OCTET | Defined in |
| GERAN Cell | | STRING | TS 36.413. |
| Information | | | |

The Last Visited NG-RAN Cell Information IE contains information about a cell. For a NR cell, the IE contains information about a set of NR cells with the same NR absolute radio frequency channel number (ARFCN) for reference point A, and the Global Cell ID IE identifies one of the NR cells in the set. The information is to be used for radio resource management (RRM) purposes.

| | | | IE type and | |
|---|---|---|---|---|
| IE/Group Name | Presence | Range | reference | Semantics description |
| Global Cell ID | M | | NG-RAN | |
| | | | CGI | |
| | | | 9.3.1.73 | |
| Cell Type | M | | 9.3.1.98 | |
| Time UE Stayed in | M | | INTEGER | The duration of time the UE |
| Cell | | | (0 . . . 4095) | stayed in the cell, or set of |
| | | | | NR cells with the same NR |
| | | | | ARFCN for reference point |
| | | | | A, in seconds. If the duration |
| | | | | is more than 4095 s, this IE is |
| | | | | set to 4095. |
| Time UE Stayed in | O | | INTEGER | The duration of time the UE |
| Cell Enhanced | | | (0 . . . 40950) | stayed in the cell, or set of |
| Granularity | | | | NR cells with the same NR |
| | | | | ARFCN for reference point |
| | | | | A, in 1/10 seconds. If the |
| | | | | duration is more than 4095 s, |
| | | | | this IE is set to 40950. |
| HO Cause Value | O | | Cause | The cause for the handover. |
| | | | 9.3.1.2 | |
| Last Visited PSCell | | 0 . . . | | List of cells configured as |
| List | | <maxnoofPSCellsPerPri- | | PSCells. Most recent PSCell |
| | | maryCellinUEHistoryInfo> | | related information is added |
| | | | | to the top of the list. |
| >Last Visited | M | | 9.3.1.235 | The PSCell related |
| PSCell Information | | | | information. |

| Range bound | Explanation |
|---|---|
| maxnoofPSCellsPerPri- | Maximum number of last visited PSCell |
| maryCellinUEHistoryInfo | information records that can be reported |
| | in the IE. Value is 8. |

Beginning with release 17, UHI and MHI may also contain history information about PSCells.

Release 17 work in UE history information has progressed to incorporate PSCell history information. The responsibility for collection of UE history information is split between the master node (MN) and the secondary node (SN). The MN is responsible for collection of PCell related information, and the SN is responsible for collecting PSCell related information. The MN obtains the information collected by the SN through subscription, querying, and/or SN release procedures. Finally, the MN correlates PSCell information from the SN with the collected PCell information. This correlated UE history information is then sent to the target MN during handover.

Information present in MHI and UHI includes the following:
A list of previous PCells: UHI contain a list of previously visited PCells capped to a maximum of 16.
A list of previous PSCells: UHI contain a list of PSCells visited per PCell. This is capped at 8 per PCell for UHI.
Duration of stay in each cell: UHI contain the duration the UE stayed in each PCell and PSCell. This duration can be a maximum value of 4095 seconds (˜68 minutes). There is an additional IE that has a higher granularity.
Handover cause: UHI contains the cause of handover (inter-MN). This is however not present in PSCell related UHI.
Cell type: UHI finally contains information about the type of cell enumerated as (very small, small, medium, large, . . . ).

WO2021028893A1 (Enhancements in Mobility History Information) describes methods for operating a UE comprising: receiving a request for UE mobility history information from a network node: generating a UE mobility history report; and transmitting the UE mobility history report to the network node, wherein the UE mobility history report comprises a beam related information, sensor information, location information, and/or dual connectivity information for the UE.

Beam related information comprises: (a) a beam identifier of a beam monitored by the UE: (b) beam identifiers of all beams monitored for a single network transceiver node: (c) a beam identifier of a strongest beam monitored for a single network transceiver node: (d) timing information; and/or (e) a measurement time and/or discontinuous reception (DRX) related information.

The 3GPP RAN3 Study Item (SI) “Study on enhancement for data collection for NR and EN-DC” studied general high-level principles, artificial intelligence (AI)/machine learning (ML) functional framework, and the potential use cases, and the identified potential solutions for these use cases. The accomplishments of the study for AI enabled RAN are documented in 3GPP TR 37.817 v17.0.0. The normative work based on the conclusion of Rel-17 SI is currently undertaken in 3GPP Rel-18. The related Work Item (WI) is described in RP-213602.

The functional framework for AI/ML in RAN captured in 3GPP TR 37.817 v17.0.0 is depicted in FIG. 3. The functional framework states that the Model Training function is a function that performs the AI/ML model training, validation, and testing and which may generate model performance metrics as part of the model testing procedure, whereas the Model Inference function is a function that provides AI/ML model inference output (e.g., predictions or decisions).

3GPP TR 37.817 v17.0.0, section 5.3.2.5, describes that AI/ML-based mobility optimization can generate as output, among other information, UE trajectory prediction (latitude, longitude, altitude, cell ID of UE over a future period of time), with the following note: whether the UE trajectory prediction is an external output to the node hosting the model inference function should be discussed during the normative work phase.).

The various participants in the normative work phase discussed whether there is a need to transfer the predicted UE trajectory over the Xn interface. Some participants believe the predicted trajectory information, together with other information, may help an NG-RAN node to select a more proper handover target cell. UE trajectory prediction is an important output for mobility optimization use case and may assist the target NG-RAN node to make further predictions of UE trajectory and UE handover decisions. Because the predicted UE trajectory may comprise locations or camp cells and the corresponding time interval, it can be later compared to the actual UE trajectory, for the purpose of performance evaluation of one AI/ML model.

The participants also discussed the feasibility of transferring the UE trajectory prediction, which depends on how the information is encoded. If the information is encoded as a prediction in terms of cells the UE will pass through, then the transfer may be reasonable. If the information is supposed to provide predicted geolocation of the UE in time, this becomes first complex, second sensitive, and third it imposes a requirement on the radio access network (RAN) to be able to geolocate the UE.

The participants also discussed that delivering the predicted trajectory during handover may be useful, e.g., beam-level prediction may be used for configuring target beams. Predicted UE trajectory may be transferred via the Xn interface to benefit the target NG-RAN node to perform subsequent network optimization. The definition of the predicted UE trajectory may include UE serving cells which will be resided in, or the predicted UE geographic location.

Cell-based, beam-based (e.g., for FR2), and UE geographic location may all be considered because the usefulness and feasibility of the different granularities of the information depend on the use case, frequency layer, and timescale involved, so tradeoffs exist between the options in terms of accuracy and simplicity.

Cell-based UE trajectory prediction has the same structure as UE history information IE. Cell-based UE trajectory prediction is provided as a list of cells into the future, each of which is indicated together with an expected time of stay into the cell. Cell based UE trajectory prediction is transferred via existing handover (HO) signaling messages.

There currently exist certain challenges. For example, the UE trajectory prediction information is to be sent from the source node of a mobility event (e.g., the source RAN node of a handover, or a PSCell change) to the target node of the mobility event. For example, when an Xn-based handover is completed, the UE is connected to the target gNB and the target gNB sends an XnAP UE CONTEXT RELEASE message to the source gNB to indicate to the source gNB that the resources associated to the UE (including the UE context of the UE just handed over) are allowed to be released. After releasing the UE context for such UE, the UE for which the UE trajectory prediction information was transferred is no longer known at the source gNB. Thus, if the source gNB (i.e., the old serving gNB before handover) wants to receive from the target gNB (i.e., the new serving gNB after handover) feedback related to the UE trajectory prediction information previously sent to the target gNB, the source gNB will no longer be able to associate the feedback to the UE and therefore to the trajectory prediction performed for the UE. In other words, the source node cannot verify whether and to what extent the information included in the UE trajectory prediction information is accurate.

A similar limitation exists for mobility for UEs in RRC_INACTIVE state. When a UE attempts to resume towards a new target network node that does not host the UE context for the UE, the target network node attempts to retrieve the UE context from the old anchor node (or source network node) where the UE context is stored (e.g., via the XnAP Retrieve UE context procedure). The anchor network node sends the UE context to the target node, and together with it (or as part of the UE context), it can also send a UE trajectory prediction information for the UE. Once the UE context is relocated to the target network node, the source (anchor) node releases the UE context. Therefore, the same limitation indicated above exists, where the old anchor node will not be able to verify whether and to what extent the predictions included in the UE trajectory prediction information are accurate.

Another problem with the existing technology is that the UE trajectory prediction may comprise a list of several future cells the UE will connect to, and the source gNB should receive feedback not only from the immediate next cell but also from several future cells. For example, assume that a UE is handed over from gNB1 to gNB2, and gNB1 signals a UE trajectory prediction for three future cells: cell1, cell2, and cell3, where cell1 is from gNB2, and the others are from gNB3. However, after connecting to cell1, the UE does not move in the direction of cell2 but rather cell4 from gNB4: during the handover from gNB2 to gNB4, gNB2 sends a new UE trajectory prediction to gNB4. Because the original UE trajectory prediction from gNB1 is no longer available to gNB4, gNB4 does not know that it needs to signal to gNB1 the true UE trajectory. Without the feedback from gNB4, gNB1 cannot improve its predictions on UE trajectory more than one step ahead in time.

Another problem is that a UE trajectory prediction may include several future cells the UE is assumed to move through, served by many different RAN nodes. While the prediction may be passed from serving node to target node during mobility, it may not be possible to identify the RAN node that originated the prediction. Namely, if a RAN node produces feedback consisting of a measured UE trajectory (in terms of visited cells) the RAN node is not able to identify the RAN node to which such feedback should be signaled. It is therefore not possible for the node that originates the prediction to use the feedback to check how accurate the prediction was, or to determine whether the models/algorithms used to derive the prediction should be e.g. updated, retrained, dismissed (and not used), or replaced.

### SUMMARY

As described above, certain challenges currently exist with feedback on predicted user equipment (UE) trajectory. Certain aspects of the present disclosure and their embodiments may provide solutions to these or other challenges. For example, in particular embodiments the source node of a mobility event (e.g., of a handover, or a PSCell Addition/PSCell Change, or the anchor node in case of an attempt to resume from RRC_INACTIVE) is enabled to receive feedback related to UE trajectory prediction information and use it to verify whether and how accurate the predictions comprised in the UE trajectory prediction information are and possibly use such feedback for training (or retraining) AI/ML model(s) and algorithm(s), or in general improve any type of algorithm used for producing UE trajectory prediction information. In some cases, the source node may instruct the recipient of the UE trajectory information to provide feedback information to a third node.

In general, particular embodiments include assistance information for feedback sent by the node performing the UE trajectory prediction. The assistance information is sent together with the UE trajectory prediction. Some embodiments include a request for feedback made by the node performing the UE trajectory prediction. Some embodiments include reception of feedback itself, and how it is sent to the node requesting it or another node.

According to some embodiments, a method performed by a first network node comprises obtaining a user equipment UE trajectory prediction and transmitting the UE trajectory prediction to a second network node and an indication requesting feedback regarding the UE trajectory prediction. The indication requesting feedback comprises assistance information for associating an identifier with the requested feedback. The method further comprises receiving feedback regarding the UE trajectory prediction from a third network node based on the transmitted assistance information.

In particular embodiments, the second network node and the third network node are the same network node (e.g., a RAN node). In particular embodiments, the second network node may be a RAN node, and the third network node may be, e.g., an OAM node.

In particular embodiments, the assistance information, comprised in the indication requesting feedback regarding the UE trajectory prediction transmitted to the second network node, comprises an identifier for associating the requested feedback with the UE trajectory prediction. For example, the identifier may comprise a feedback identifier and/or an identifier of a UE.

In particular embodiments, the received feedback includes the identifier for associating the requested feedback with the UE trajectory prediction.

In particular embodiments, the assistance information, comprised in the indication requesting feedback regarding the UE trajectory prediction transmitted to the second network node, comprises an identifier of a network node for receiving the feedback.

In particular embodiments, receiving the feedback comprises receiving an artificial intelligence/machine learning assistance data update message.

In particular embodiments, the assistance information, comprised in the indication requesting feedback regarding the UE trajectory prediction transmitted to the second network node, comprises an indication that feedback is requested after a threshold number of handovers.

In particular embodiments, the received feedback comprises a list of UE trajectory cells and/or a dwelling time for each cell of a list of UE trajectory cells.

In particular embodiments, the method further comprises training an artificial intelligence or machine learning model with the received feedback.

According to some embodiments, a method performed by a second network node comprises receiving a UE trajectory prediction and an indication requesting feedback regarding the UE trajectory prediction. The indication requesting feedback comprises assistance information for associating an identifier with the requested feedback. The method further comprises transmitting feedback regarding the UE trajectory prediction to a first network node based on the assistance information.

In particular embodiments, the first network node comprises a radio access network (RAN) node or an operations and management (OAM) node.

In particular embodiments, the assistance information, comprised in the indication requesting feedback regarding the UE trajectory prediction received from the first network node, comprises an identifier for associating the requested feedback with the UE trajectory prediction. The identifier may comprise an identifier of a UE.

In particular embodiments, the transmitted feedback includes the identifier for associating the requested feedback with the UE trajectory prediction.

In particular embodiments, the assistance information, comprised in the indication requesting feedback regarding the UE trajectory prediction received from the first network node, comprises an identifier of a network node for transmitting the feedback.

In particular embodiments, transmitting the feedback comprises transmitting an artificial intelligence/machine learning assistance data update message.

In particular embodiments, the assistance information, comprised in the indication requesting feedback regarding the UE trajectory prediction received from the first network node, comprises an indication that feedback is requested after a threshold number of handovers.

In particular embodiments, the transmitted feedback comprises a list of UE trajectory cells and/or a dwelling time for each cell of a list of UE trajectory cells.

According to some embodiments, a network node comprises processing circuitry operable to perform any of the methods of the network nodes described above.

Also disclosed is a computer program product comprising a non-transitory computer readable medium storing computer readable program code, the computer readable program code operable, when executed by processing circuitry to perform any of the methods performed by the network nodes described above.

Certain embodiments may provide one or more of the following technical advantages. For example, particular embodiments enable the network node performing a UE trajectory prediction to request feedback information from other network nodes involved in the UE trajectory (e.g., to which the UE is handed over). Some embodiments enable the network nodes sending the feedback information to identify the network node that performed the UE trajectory prediction, to send the feedback directly to it or via other network nodes. Assistance information contained in the feedback information enables the network node that performed the UE trajectory prediction to link it to the UE trajectory prediction without storing the UE context for too long.

Some embodiments verify whether and how accurate the predictions comprised in the UE Trajectory Prediction information are and possibly use such feedback for training (or retraining) AI/ML model(s) and algorithm(s), or in general improve any type of algorithm, used for producing UE Trajectory Prediction information.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating the NG-RAN architecture;

FIG. 2 is a block diagram illustrating the architecture for separation of gNB-CU-CP and gNB-CU-UP:

FIG. 3 is a block diagram illustrating the functional framework for AI/ML in RAN captured in 3GPP TR 37.817 v17.0.0;

FIG. 4 is a block diagram illustrating an example wireless network:

FIG. 5 illustrates an example user equipment, according to certain embodiments:

FIG. 6 illustrates an example virtualization environment, according to certain embodiments:

FIG. 7 illustrates an example telecommunication network connected via an intermediate network to a host computer, according to certain embodiments:

FIG. 8 illustrates an example host computer communicating via a base station with a user equipment over a partially wireless connection, according to certain embodiments:

FIG. 9 is a flowchart illustrating a method implemented, according to certain embodiments:

FIG. 10 is a flowchart illustrating a method implemented in a communication system, according to certain embodiments;

FIG. 11 is a flowchart illustrating a method implemented in a communication system, according to certain embodiments:

FIG. 12 is a flowchart illustrating a method implemented in a communication system, according to certain embodiments:

FIG. 13A is a flowchart illustrating a method performed by a wireless device, according to certain embodiments:

FIG. 13B is a flowchart illustrating a method performed by a first network node, according to certain embodiments:

FIG. 13C is a flowchart illustrating a method performed by a second network node, according to certain embodiments:

FIG. 14 is a flowchart illustrating another method performed by a first network node, according to certain embodiments; and

FIG. 15 is a flowchart illustrating another method performed by a second network node, according to certain embodiments.

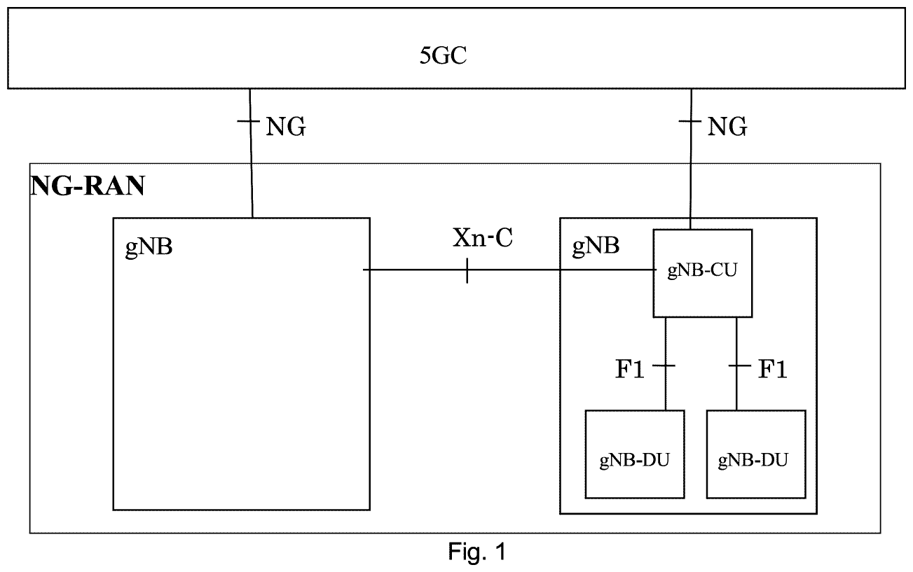

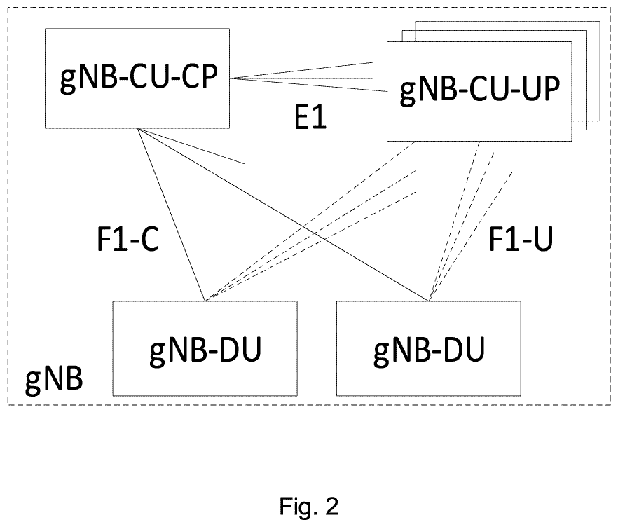

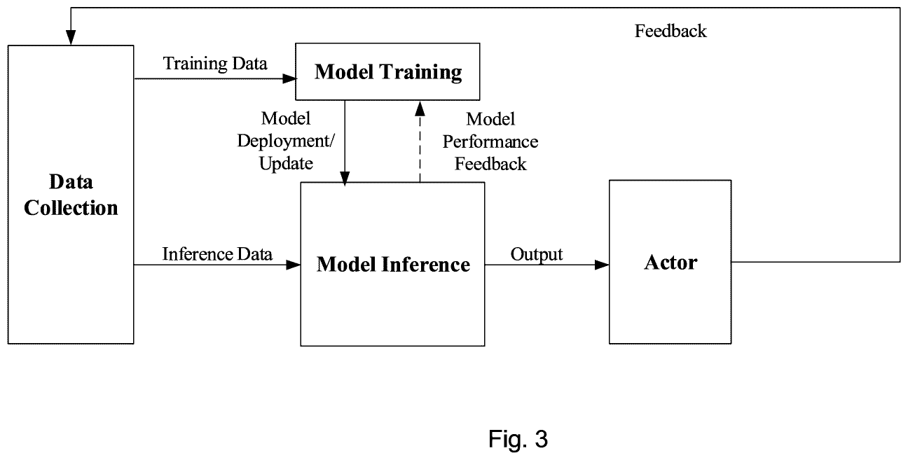

### DETAILED DESCRIPTION

Particular embodiments are described with respect to a network node. A network node may be a radio access network (RAN) node, an operation and management (OAM) node, a Core Network (CN) node, a service management and orchestration (SMO) node, a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, gNB-DU, eNB-CU, eNB-CU-CP, eNB-CU-UP, eNB-DU, integrated access and backhaul (IAB) node, IAB-donor DU, IAB-donor-CU, IAB-DU, IAB-MT, O-CU, O-CU-CP, O-CU-UP, O-DU, O-RU, O-eNB, a cloud-based network function, and/or a cloud-based centralized training node.

In particular embodiments, a first network node (source network node) determines, e.g., as one of the outputs of an artificial intelligence (AI)/machine learning (ML) model, user equipment (UE) trajectory prediction information comprising a list of cells and/or a list of reference signal beams, such as synchronization signal block (SSB) reference signals, and sends the UE trajectory prediction information to one or more other network nodes (target network nodes). The UE trajectory prediction information may further include, in association to the list of cells and/or the list of reference signals, an indication of the network node identity to which the cells or reference signals belong.

According to particular embodiments, as part of or together with UE trajectory prediction information, the source network node sends to one or more target network nodes assisting information for feedback on predicted UE trajectory (as described below). The source network node, upon receiving from the other target network node(s) feedback on UE trajectory information, may improve future determination of UE trajectory prediction information (e.g., for other UEs with same or similar radio measurements/services as the UE for which the UE trajectory prediction information was determined and for which the feedback was received).

The source network node may send UE trajectory prediction information to only one target network node, or to multiple target network nodes, optionally depending on the type of mobility event. In one example, the predicted UE trajectory may involve cells and/or reference signal coverage areas (such as SSB coverage areas) of different neighboring network nodes. Therefore, in this example, the source node may transmit the UE trajectory prediction information to all nodes involved in the predicted UE trajectory. The same principle applies for conditional handover, where the source network node sends the UE trajectory prediction to one or multiple target network node candidates.

The source network node may send UE trajectory prediction information to one target network node for any of the following:
a handover that is not a conditional handover (i.e., in case of “normal” handover, or in case of dual active protocol stack (DAPS) handover).
a PSCell addition that is not a conditional PSCell addition.
a PSCell change that is not a conditional PSCell change, and/or
a response to a request of UE context retrieval.

In one example, the source network node may transmit the UE trajectory prediction information by adding a cause value for transmitting such information. The cause value may indicate the reason for transmitting the UE trajectory prediction information, such as predicted or planned handover, a PSCell addition, a PSCell change, etc.

The source network node may send UE trajectory prediction information to more than one (candidate) target network nodes for any of the following:
a handover that is a conditional handover, or
a PSCell addition that is a conditional PSCell addition, or
a PSCell change that is a conditional PSCell change

The source network node may send different UE trajectory prediction information to different (candidate) target network nodes, or the source network node may send different UE trajectory prediction information to a same target network node.

For example, for a T-type intersection where a moving UE is in cell A, if the UE turns right the UE will go to cell B and if the UE turns left the UE will go to cell C. In that case, the source network node may know that the UE will later go to cell D (if it went to cell B) or go to cell E (if it went to cell C), so there are two possible UE trajectory predictions: 1) “Cell A, (then) Cell B, (then) Cell D” (trajectory 1): 2) “Cell A, (then) Cell C, (then) Cell E” (trajectory 2).

The source network node may send UE trajectory prediction information with weighting factors indicating the possibility that the UE will be in one or more of the cells or reference signal coverage areas indicated by the UE trajectory information. Especially in the case of conditional handover that depends on the cell that would be the next hop meaning which of the candidate cells will be the actual target cell and correspondingly the next hop, leading to different sequences with cells. In one example, the source node in the conditional handover sends one UE trajectory prediction information to each target node, but with weights for the candidate target cells. In another example, the source node sends different UE trajectory prediction information with the different sequence of cells to each candidate target cell. In that case, the source node may assign different priority to the different sequences indicating the probability for each sequence to happen.

In some embodiments, the source network node is a RAN node and sends UE trajectory prediction information to one or more other target network nodes which are also RAN nodes. The target network node(s) may send feedback on UE trajectory prediction information to a third network node that is not a RAN node, but e.g., an OAM node/function or a CN node/function. In this option, a training process for an AI/ML model used to infer UE trajectory prediction information may be deployed at OAM.

In one example, the source node may request the target node, as part of the signaling of predicted UE trajectory information, feedback information related to the provided predicted UE trajectory information, and may optionally indicate whether the requested feedback information should be provided to the source node or to a third network node (e.g., an OAM node or a CN node/function). To enable a functionality where feedback on the predicted UE trajectory may be provided to the one or more nodes indicated by the source network node, the source node provides assistance information for feedback on predicted UE trajectory. Such information may include any one or more of the following:
an identifier of a prediction, such as a prediction ID or an AI/ML model ID, associated to a process (e.g., an AI/ML model or a prediction process) used to produce at least part of the information comprised in the UE trajectory prediction information.
an identifier of a requested feedback, such as a feedback ID to identify feedback associated to the UE trajectory prediction information or to identify feedback associated to a piece of information (e.g., an output of an AI/ML model) comprising UE trajectory prediction information that the source network node requests/expects the target network node to return in a message for the source network node, wherein such message carries the same identifier (or a new identifier derived from the feedback ID), together with feedback on UE trajectory prediction information.
The request for feedback information may contain the number of network nodes the UE needs to be handed over to before sending the feedback information (e.g., feedback information may be sent after the 1^{st} hop, the 3^{rd} one, the last one, or any combination of these).
an identifier of a pattern, such as a pattern ID identifying or being associated to at least part of the UE trajectory prediction information, such as any combination of the following options:
   all the cells of the list of cells included in the UE trajectory prediction information
   all the reference signal beams included in the list of reference signal beams comprised in the UE trajectory prediction information
   a combination without repetition of at least part of the cells of the list of cells included in the UE trajectory prediction information
   a combination without repetition of at least part of the reference signal beams of the list of reference signal beams included in the UE trajectory prediction information
   a combination without repetition of at least part of the cells and/or reference signal beams of the list(s) of cells and/or reference signal beams included in the UE trajectory prediction information
   a one-way or a two-way hashing function generated value that uses any of the above specified values as inputs
   a predicted dwelling time in one or more cells of the list of cells included in the UE trajectory prediction information.
   a predicted dwelling time in one or more reference signal beams of the list of reference signal beams included in the UE trajectory prediction information.
an identifier of a UE or an identifier of a group of UEs, such as a RAN UE ID, identifying a UE in a semi-permanent manner across multiple network nodes, including the first network node and one or more target network nodes.
the number of cells and/or reference signal beams included in the UE trajectory prediction information.
an identifier related to the cells and/or reference signal beams included in the UE trajectory prediction information.
An indication or identifier of the network node to which the cells or reference signals beams indicated in the UE trajectory prediction is associated to.
an indication that all or part of the assisting information for feedback on predicted UE trajectory should be forwarded in subsequent mobility events
   an optional indication of how long the information should be forwarded may also be included. For example, the indication may be related to a number of hops (e.g., number of cells and/or reference signal beams the UE connects to and/or network nodes) or an amount of time (e.g., as a sum of total dwelling time in cells and/or reference signal beams and/or network nodes, a time interval, or an expiration timestamp in the future). Upon receiving the indication, a RAN node decides if it will send the feedback to the previous nodes and/or the source node.
an identifier indicating to where the feedback should be sent, e.g., back to the first network node or to another network node (e.g., another RAN node or an OAM node/function or a CN node/function).
for each cell entry in the UE trajectory prediction, an identifier uniquely identifying the network node that performed the UE trajectory prediction for the entry
an indication of the node where the feedback needs to be signaled as an embedded indication in the list of cells constituting the predicted UE trajectory. Namely, if the predicted UE trajectory consists of Cell 1, Cell 2, Cell 3, Cell 4 the additional assistance information may associate to one of such cells an indication, e.g. a feedback reception flag, that will let future target nodes know that the predicted UE trajectory will have to be sent to the node serving such cell. As an example, the enhanced predicted UE trajectory may consist of: Cell 1, Cell 2+Feedback reception flag, Cell 3, Cell 4.
an indication of the node from which the UE trajectory feedback will be sent from. Similar to the embodiment above, such indication may be provided either explicitly as a node or cell identifier indicating the node that should send the trajectory feedback, or as an indication associated to one of the cells in the trajectory prediction. Such indication may be referred to as a feedback signaling flag.

The assistance information for feedback on predicted UE trajectory may be related to the complete predicted UE trajectory (i.e. all entries/cells) or may be related to one entry/cell only (i.e. attached to one cell/entry). For the latter, only some of the entries (or all) may have the assisting information for feedback attached.

The source network node may request to receive from the target network node(s), as feedback on predicted UE trajectory, one or more of the assisting identifiers described above.

In some embodiments, sending one or more of the above identifiers corresponds to an implicit request of the source network node to the target network node to provide such identifier(s) in a return message towards the source network node. The return message may be implemented as a message included in the same procedure containing the UE trajectory prediction information and/or the above identifier(s), or as a message not included in same procedure containing the UE trajectory prediction information and/or the above identifier(s).

In one embodiment, the UE trajectory prediction may be updated by target nodes that serve the UE after the prediction was made. As an example, network node 1 may predict the trajectory prediction consisting of Cell 1, Cell 2, Cell 3, Cell 4. However, when the UE moves to network node 2, serving Cell 2, network node 2 may amend the prediction to Cell 1, Cell 2, Cell 5, Cell 6. In this case, network node 2 will add in a message containing the new UE trajectory prediction information stating that the UE trajectory feedback needs to be signaled back also to network node 2.

In one embodiment, such information added by network node 2 may be in the form of adding the feedback reception flag to any of the cells in the prediction whose hosting node should receive the prediction feedback.

As a non-limiting example, the assistance information is included in a (preceding) XnAP HANDOVER REQUEST message and the return message is a response message (e.g., an XnAP UE CONTEXT RELEASE message to close the handover procedure). As another example, the return message may be a notification message, such as: an XnAP ACCESS AND MOBILITY INDICATION message, an XnAP HANDOVER SUCCESS message, or an XnAP HANDOVER REPORT message. In another example, the return message may be the AI/ML ASSISTANCE DATA UPDATE message.

In some embodiments, an explicit request for feedback is sent together with the assistance information. The explicit request for feedback may be any of the following:
An indication that feedback needs to be received from neighbor network nodes, or from neighbors of neighbor network nodes (2^{nd} level, or second tier neighbor) or up to the n^{th} level of neighbors.
An indication that feedback needs to be received for cells of neighbor network nodes, and/or for cells of neighbors of neighbor network nodes (2^{nd} level, or second tier neighbor) or up to the n^{th} level of neighbors.
An indication that feedback needs to be received for reference signal beams of neighbor network nodes, and/or for reference signal beams of neighbors of neighbor network nodes (2^{nd} level, or second tier neighbor) or up to the n^{th} level of neighbors.
An indication that feedback is needed after n^{th} handovers.
An indication that feedback is needed if the UE trajectory prediction differs from the actual UE trajectory (e.g., logged in UHI or MHI).

The source network node, in the same message carrying the UE trajectory prediction information (to one or more target network nodes), or using a different message, may implicitly or explicitly request the target network node(s) to provide feedback on predicted UE trajectory. Such a request may be sent along with or instead of the request to obtain the one or more identifiers listed above.

The requested feedback may be to obtain a list of UE trajectory cells, i.e., to obtain a list indicating which cells of the list of cells included in the UE trajectory prediction information have been visited by the UE in its trajectory, and optionally other characteristics or performances associated to those cells (e.g., the dwelling time for each cell, the time spent by the UE while being in a certain Radio Resource Control (RRC) state and camping or being served by the cell, performance of the handed-over UE in the target cell). The list may be ordered using a time criterion, e.g., the first entry of the list corresponds to the most recent cell visited by the UE, the second entry of the list corresponding to the second last visited cell visited by the UE, and so on.

In some embodiments, the list of UE trajectory cells may be represented as a list of values, where the position in the list represents a cell of the UE trajectory prediction information actually visited by the UE. In some embodiments, the list of UE trajectory cells may be represented as a list of values, where the position in the list represents a cell of the UE trajectory prediction information, and the value in that position indicates the dwelling time of the UE in that cell. A zero dwelling time indicates that the cell indicated by the corresponding position of the list was not visited by the UE.

In some embodiments, the list of UE trajectory cells may be represented as a bitmap, where the position in the bitmap represents a cell in the UE trajectory prediction information, and bit set to 1 in a certain position indicates that the UE has visited the cell corresponding to that position, and a value 0 indicates that the UE has not visited the corresponding cell.

In some embodiments, the list of UE trajectory cells may be represented as a list of sequences, where the position in the list represents a cell in the UE trajectory prediction information, and the sequence in that position is a list of reference signal beams of the cell visited by the UE.

In some embodiments, the list of UE trajectory cells may be represented as a list of sequences, where the position in the list represents a cell in the UE trajectory prediction information, and the sequence in that position is a list of performance indicators for the UE in that cell. A performance may refer to a throughput, a delay, a jitter, a packet loss, etc.

In some embodiments, the list of cells the UE visited is represented by the UE history information (UHI) or mobility history information (MHI) for the UE, as received by the network node sending the feedback. UHI and/or MHI is appended with the assisting information for feedback.

The requested feedback may be to obtain a list of UE trajectory reference signal beams, i.e., to obtain a list indicating which reference signal beams of the list of reference signal beams included in the UE trajectory prediction information have been visited by the UE in its trajectory, and optionally other characteristics or performances associated to those reference signal beams (e.g., the dwelling time for each reference signal beams, the time spent a certain RRC state while camping or being served by the reference signal beams).

The requested feedback may be to obtain a suggested set of changes to the model weights/parameters that have been used to make the prediction. In this case, the candidate target node(s) (in combination with a third node, e.g., OAM system or on its own) may feedback suggested changes to the model parameters on the source node instead of outcomes of actual UE trajectory. Such feedback may be provided both at the level of cell-level trajectory and/or reference signal level.

In one option, when UE trajectory prediction information is sent to multiple candidate target network nodes, feedback on predicted UE trajectory is sent to the source network node only by the candidate target network node involved in the actual execution of the mobility event.

In another option, when UE trajectory prediction information is sent to multiple candidate target network nodes, feedback on predicted UE trajectory is sent to the source network node by multiple candidate target network nodes, i.e., not only by the candidate target network node involved in the actual execution of the mobility event. In this case, the feedback information may consist of other identifiers that may be used to differentiate if the feedback has been received from the candidate target node that was involved in the mobility event or not.

In another option, when the UE trajectory prediction information is sent to multiple candidate target network nodes, the candidate nodes that the UE will actually visit may send feedback. In one alternative, every candidate node that the UE visited may send feedback directly to the source node. In another alternative, each of the candidate nodes sends feedback to the node that was the previous hop and then the feedback may be gathered and cascaded to the source node.

The target network node involved in the execution of the mobility event, when receiving from the source network node assisting information for feedback on predicted UE trajectory and/or a request (implicit or explicit) to send feedback on predicted UE trajectory, may send such feedback to the source network node using one or more messages.

The source network node receives feedback on predicted UE trajectory and compares it against the predicted information (or forwards the feedback on predicted UE trajectory to a third network node which performs the above comparison, e.g., a network node implementing a training function of an AI/ML model). The comparison may be used, for example, to determine the accuracy of a certain pattern (e.g., a list of consecutive cells forecasted to be visited by the UE) and to improve the UE trajectory prediction information for future mobility events. For example, the source network node may have sent to a target network node several instances of UE trajectory prediction information containing a list of cells “A, B, C” and receives as feedback in return a number of instances of list of UE trajectory cells indicating that visited cells are “A, B, C” with a very short dwelling time for cell “B”. Then the source network node may propose the target network node to adjust the mobility trigger points from B to C to delay the handover from B to C.

In another embodiment, the source network node on receiving feedback that suggests changes to model parameters may directly update the model with the suggestion or use feedback information received from other nodes or other input data during a certain time span to derive new model parameter updates.

In one embodiment, the RAN node that requests to receive the UE trajectory feedback may not have a direct signaling connection with the target RAN node. In this case, the request for UE trajectory feedback may be signaled over the RAN to CN interface and it may be forwarded by the CN to the appropriate target RAN node.

In one embodiment, the RAN node that signals the UE trajectory feedback to the source node may not have a direct signaling connection with the source RAN node. In this case, either the UE trajectory feedback may be signaled over the RAN to CN interface and it may be forwarded by the CN to the appropriate source RAN node.

In this case, the assistance information included with the UE trajectory prediction that indicated receiving the UE trajectory feedback may include the tracking area indication of the node where the UE trajectory feedback shall be signaled. With this information the RAN node that is supposed to signal back the UE trajectory feedback is able to provide to the CN the information needed to route the UE trajectory feedback to the appropriate source RAN node.

In one example of the embodiments described above, the UE trajectory prediction may be encoded as follows and signaled to the next serving RAN node via a message such as the Xn Handover Request message or the Xn Retrieve UE context message.

The Cell Trajectory Prediction IE contains the list of predicted NR cells the UE will move to after being handed over from the source NG-RAN Node.

| | | | IE Type and | |
|---|---|---|---|---|
| IE/Group Name | Presence | Range | Reference | Semantics Description |
| Predicted Trajectory | | 1 . . . | | List of cells where the |
| Cell List | | <maxnoofCellsTrajectoryPredict> | | UE is predicted to |
| | | | | connect, in |
| | | | | chronological order. |
| | | | | The first predicted cell |
| | | | | that the UE will move |
| | | | | to after the serving cell |
| | | | | is added to the top of |
| | | | | this list |
| >Predicted Trajectory | M | | 9.2.3.y | |
| Cell Information | | | | |

| Range bound | Explanation |
|---|---|
| maxnoofCellsTrajectoryPredict | Maximum number of cells that can be |
| | predicted for UE trajectory. Value is 8. |

The Predicted Trajectory Cell Information contains the cell ID of the predicted cell for trajectory prediction.

| | | | | |
|---|---|---|---|---|
| | | | IE type and | |
| IE/Group Name | Presence | Range | reference | Semantics description |

| | | | |
|---|---|---|---|
| CHOICE Predicted | M | | |
| Trajectory Cell | | | |
| Information | | | |
| >NG-RAN Cell | | | |
| >>Cell Global ID | M | 9.2.3.2 | |
| >>Predicted Time UE | M | INTEGER | The duration of time the |
| Stays in Cell | | (0 . . . 4095) | UE is expected to stay in |
| | | | the cell, or set of NR cells |
| | | | with the same NR ARFCN |
| | | | for reference point A, in |
| | | | seconds. If the duration is |
| | | | more than 4095 s, this IE is |
| | | | set to 4095. |
| >Feedback Signalling | O | ENUMERATED | Indicates whether the node |
| Flag | | (Sending Node, | serving the corresponding |
| | | Receiving Node, . . . ) | cell is the node sending the |
| | | | UE Trajectory Feedback or |
| | | | the node that should |
| | | | receive the Trajectory |
| | | | Feedback |

From the example above it can be seen that one or more cells in the UE trajectory prediction may be labelled with a flag indicating one or more of these options:
The node serving the flagged cell shall send the UE trajectory feedback
The node serving the flagged cell is the node that shall receive the UE trajectory feedback

The cell global identifier includes the RAN node global identifier, thus it is possible for the RAN node receiving the trajectory prediction cell information to deduce the RAN node to which the trajectory feedback needs to be sent.

In one example of the embodiments above, the UE trajectory feedback may be represented by the UE history information, as defined for the XnAP.

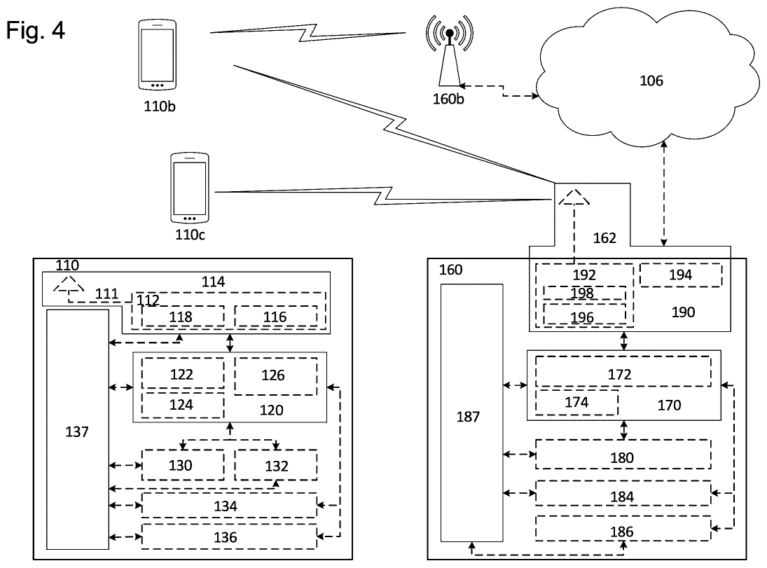

FIG. 4 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below: These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a play back appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112: rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen: if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source: in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

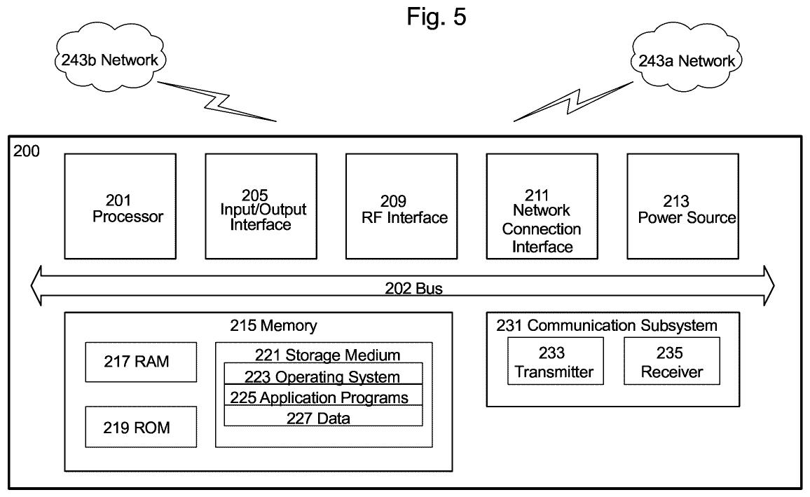

FIG. 5 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 5, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software: or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 5, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2. CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

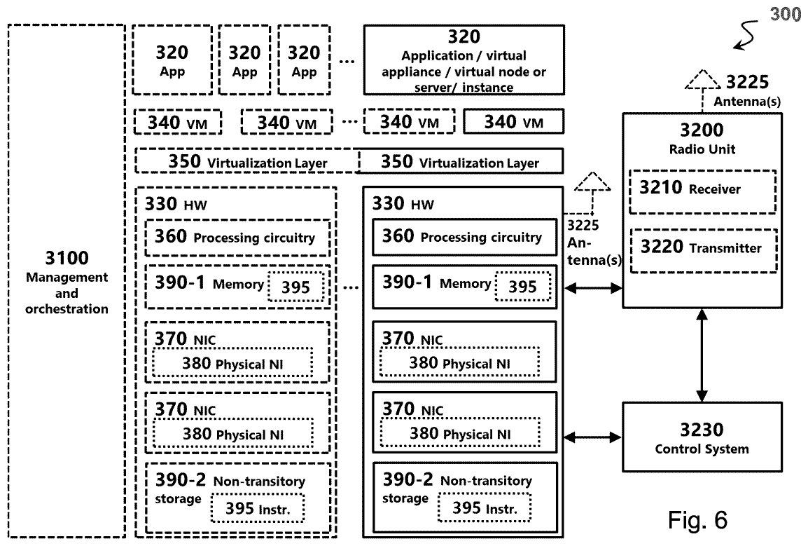

FIG. 6 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 6, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

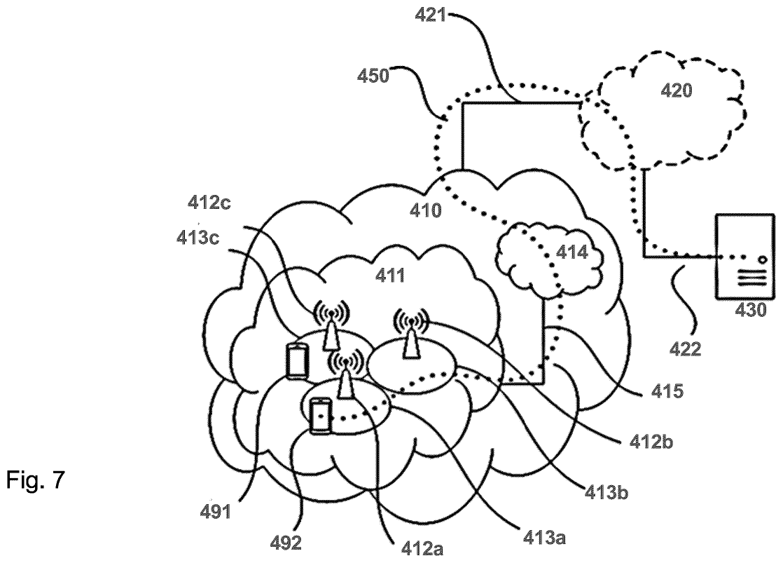

With reference to FIG. 7, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a. 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network: intermediate network 420, if any, may be a backbone network or the Internet: in particular, intermediate network 420 may comprise two or more sub-networks (not shown).

The communication system of FIG. 7 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

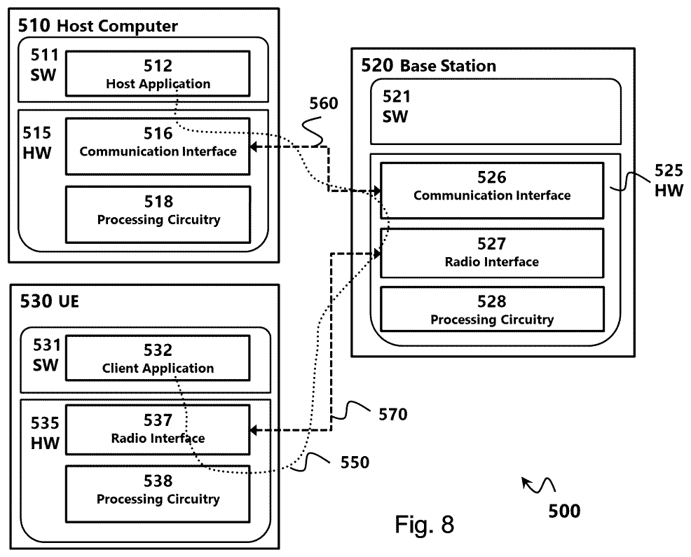

FIG. 8 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 8. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 8) served by base station 520. Communication interface 526 may be configured to facilitate connection 560 to host computer 510. Connection 560 may be direct, or it may pass through a core network (not shown in FIG. 8) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 8 may be similar or identical to host computer 430, one of base stations 412a, 412b, 412c and one of UEs 491, 492 of FIG. 4, respectively. This is to say, the inner workings of these entities may be as shown in FIG. 8 and independently, the surrounding network topology may be that of FIG. 4.

In FIG. 8, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes: the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.: the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

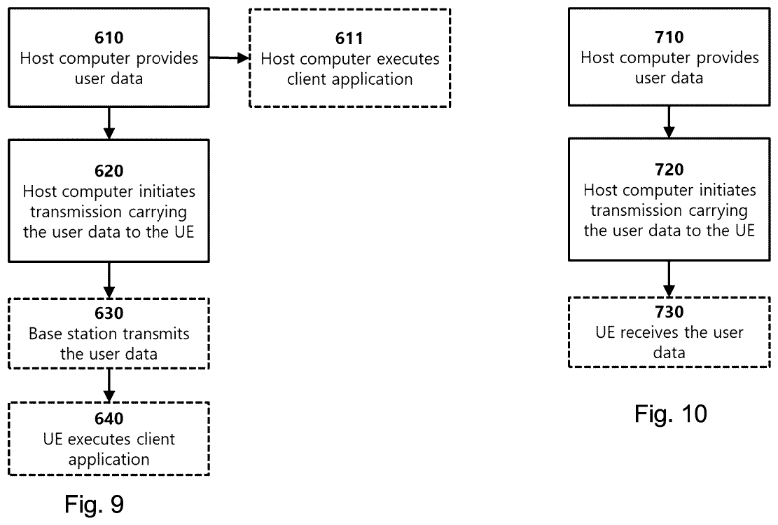

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

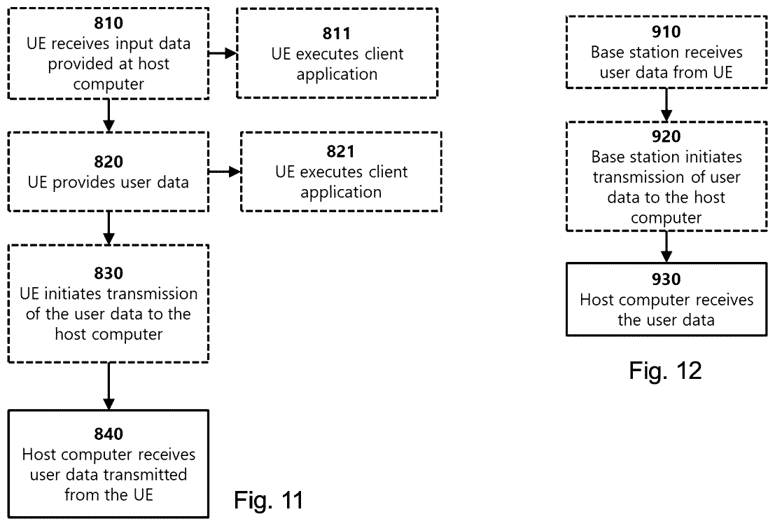

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

In the examples and embodiments described herein, when a message is transmitted to a wireless device or to a network node, the message may be transmitted directly or indirectly, via one or more intermediate network nodes or wireless devices. Similarly, when a message is received from a wireless device or to a network node, the message may be received directly or indirectly, via one or more intermediate network nodes or wireless devices.

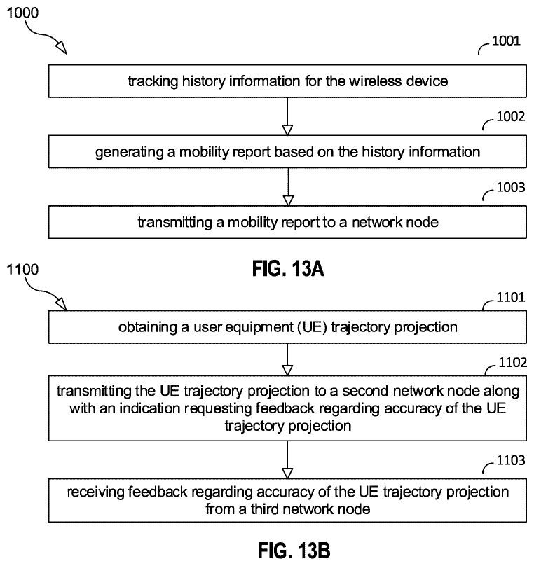

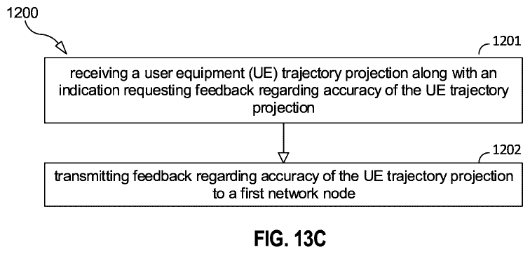

FIG. 13A is a flowchart illustrating a method 1000 performed by a wireless device according to certain embodiments. In particular embodiments, one or more steps of FIG. 13A may be performed by wireless device 110 described with respect to FIG. 4.

The method begins at step 1001, where the wireless device tracks history information for the wireless device.

At step 1002, the wireless device generates a mobility report based on the history information.

At step 1003, the wireless device transmits a mobility report to a network node. The network node may use the mobility report for training or retraining an artificial intelligence/machine learning model for predicting a mobility path of the wireless device.

Modifications, additions, or omissions may be made to method 1000 of FIG. 13A. Additionally, one or more steps in the method of FIG. 13A may be performed in parallel or in any suitable order.

FIG. 13B is a flowchart illustrating a method 1100 performed by a first network node according to certain embodiments. In particular embodiments, one or more steps of FIG. 13B may be performed by network node 162 described with respect to FIG. 4.

The method begins at step 1101, where the first network node obtains a UE trajectory prediction. The UE trajectory prediction may comprise the output of an artificial intelligence/machine learning model. The first network node may perform the training of the AI/ML model, or the first network node may obtain the UE trajectory prediction from another network node, such as an OAM node.

At step 1102, the first network node transmits the UE trajectory prediction to a second network node along with an indication requesting feedback regarding the UE trajectory prediction. The indication requesting feedback comprises assistance information for associating an identifier with the requested feedback.

The first network node may transmit the UE trajectory prediction in the same message as the indication requesting feedback regarding the UE trajectory prediction or in separate messages.

In particular embodiments, the assistance information comprises an identifier for associating the requested feedback with the UE trajectory prediction. For example, the identifier may comprise a feedback identifier and/or an identifier of a UE.

In some embodiments, the indication requesting feedback may comprise one or more messages. For example, a first message may include part of a feedback identifier associated with the UE trajectory prediction, and another message may include a second part (e.g., UE identifier) of a feedback identifier associated with the UE trajectory projection.

In particular embodiments, the assistance information comprises an identifier of a network node for receiving the feedback.

In particular embodiments, receiving the feedback comprises receiving an artificial intelligence/machine learning assistance data update message.

In particular embodiments, the assistance information comprises an indication that feedback is requested after a threshold number of handovers.

In particular embodiments, the received feedback comprises a list of UE trajectory cells and/or a dwelling time for each cell of a list of UE trajectory cells.

Other and additional examples of assistance information and received feedback are described with respect to the embodiments and examples described herein.

At step 1103, the first network node receives feedback regarding the UE trajectory prediction from a third network node. In particular embodiments, the second network node and the third network node are the same network node (e.g., a RAN node). In particular embodiments, the second network node may be a RAN node, and the third network node may be, e.g., an OAM node.

Modifications, additions, or omissions may be made to method 1100 of FIG. 13B. Additionally, one or more steps in the method of FIG. 13B may be performed in parallel or in any suitable order.

FIG. 13C is a flowchart illustrating a method 1200 performed by a second network node according to certain embodiments. In particular embodiments, one or more steps of FIG. 13C may be performed by network node 162 described with respect to FIG. 4.

The method begins at step 1201, where the second network node receives a UE trajectory prediction along with an indication requesting feedback regarding the UE trajectory prediction. The indication requesting feedback comprises assistance information for associating an identifier with the requested feedback. The indication and the assistance information are described in more detail with respect to FIG. 13B and the embodiments and examples described herein.

At step 1202, the second network node transmits feedback regarding the UE trajectory prediction to a first network node. The feedback is described in mor detail with respect to FIG. 13B and the embodiments and examples described herein.

Modifications, additions, or omissions may be made to method 1200 of FIG. 13C. Additionally, one or more steps in the method of FIG. 13C may be performed in parallel or in any suitable order.

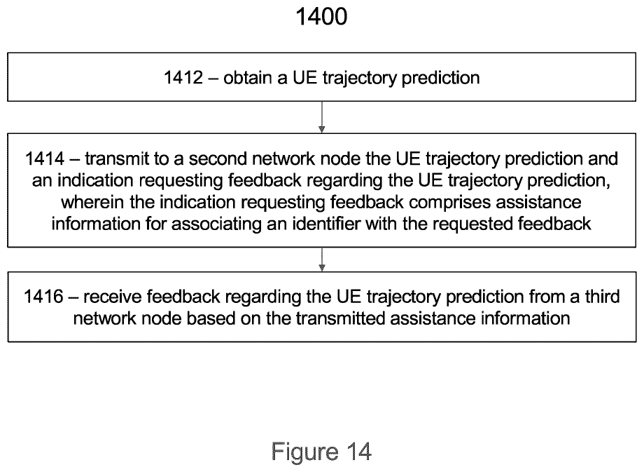

FIG. 14 is a flowchart illustrating a method 1400 performed by a first network node according to certain embodiments. In particular embodiments, one or more steps of FIG. 14 may be performed by network node 162 described with respect to FIG. 4.

The method begins at step 1412, where the first network node obtains a UE trajectory prediction. The UE trajectory prediction may comprise the output of an artificial intelligence/machine learning model. The first network node may perform the training of the AI/ML model, or the first network node may obtain the UE trajectory prediction from another network node, such as an OAM node.

At step 1414, the first network node transmits the UE trajectory prediction to a second network node along with an indication requesting feedback regarding the UE trajectory prediction. The indication requesting feedback comprises assistance information for associating an identifier with the requested feedback.

The first network node may transmit the UE trajectory prediction in the same message as the indication requesting feedback regarding the UE trajectory prediction or in separate messages.

In particular embodiments, the assistance information comprises an identifier for associating the requested feedback with the UE trajectory prediction. For example, the identifier may comprise a feedback identifier and/or an identifier of a UE.

In some embodiments, the indication requesting feedback may comprise one or more messages. For example, a first message may include part of a feedback identifier associated with the UE trajectory prediction, and another message may include a second part (e.g., UE identifier) of a feedback identifier associated with the UE trajectory projection.

In particular embodiments, the assistance information comprises an identifier of a network node for receiving the feedback.

In particular embodiments, receiving the feedback comprises receiving an artificial intelligence/machine learning assistance data update message.

In particular embodiments, the assistance information comprises an indication that feedback is requested after a threshold number of handovers.

In particular embodiments, the received feedback comprises a list of UE trajectory cells and/or a dwelling time for each cell of a list of UE trajectory cells.

Other and additional examples of assistance information and received feedback are described with respect to the embodiments and examples described herein.

At step 1416, the first network node receives feedback regarding the UE trajectory prediction from a third network node. In particular embodiments, the second network node and the third network node are the same network node (e.g., a RAN node). In particular embodiments, the second network node may be a RAN node, and the third network node may be, e.g., an OAM node.

Modifications, additions, or omissions may be made to method 1400 of FIG. 14. Additionally, one or more steps in the method of FIG. 14 may be performed in parallel or in any suitable order.

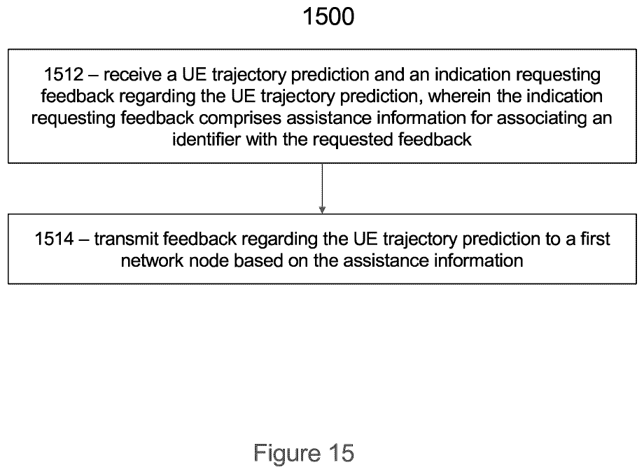

FIG. 15 is a flowchart illustrating a method 1500 performed by a second network node according to certain embodiments. In particular embodiments, one or more steps of FIG. 15 may be performed by network node 162 described with respect to FIG. 4.

The method begins at step 1512, where the second network node receives a UE trajectory prediction along with an indication requesting feedback regarding the UE trajectory prediction. The indication requesting feedback comprises assistance information for associating an identifier with the requested feedback. The indication and the assistance information are described in more detail with respect to FIG. 14 and the embodiments and examples described herein.

At step 1514, the second network node transmits feedback regarding the UE trajectory prediction to a first network node. The feedback is described in mor detail with respect to FIG. 14 and the embodiments and examples described herein.

Modifications, additions, or omissions may be made to method 1500 of FIG. 15. Additionally, one or more steps in the method of FIG. 15 may be performed in parallel or in any suitable order.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

### EXAMPLE EMBODIMENTS

### Group A Embodiments

1. A method performed by a wireless device, the method comprising:
   tracking history information for the wireless device;
   generating a mobility report based on the history information; and
   transmitting a mobility report to a network node.
2. A method performed by a wireless device, the method comprising:
   any of the wireless device steps, features, or functions described above, either alone or in combination with other steps, features, or functions described above.
3. The method of the previous embodiment, further comprising one or more additional wireless device steps, features or functions described above.
4. The method of any of the previous embodiments, further comprising:
   providing user data; and
   forwarding the user data to a host computer via the transmission to the base station.

### Group B Embodiments

5. A method performed by a first base station, the method comprising:
   obtaining a user equipment (UE) trajectory projection;
   transmitting the UE trajectory projection to a second base station along with an indication requesting feedback regarding accuracy of the UE trajectory projection; and
   receiving feedback regarding accuracy of the UE trajectory projection from a third base station.
6. A method performed by a second base station, the method comprising:
   receiving a user equipment (UE) trajectory projection along with an indication requesting feedback regarding accuracy of the UE trajectory projection; and
   transmitting feedback regarding accuracy of the UE trajectory projection to a first base station.
7. The method of embodiment 5, wherein the second base station and the third base station are the same base station.
8. The method of any one of embodiments 5-7, wherein the indication requesting feedback regarding accuracy of the UE trajectory projection comprises an identifier for associating the feedback with the UE trajectory projection.
9. The method of any one of embodiments 5-8, wherein the indication requesting feedback regarding accuracy of the UE trajectory projection comprises an identifier of a network node for receiving the feedback.
10. The method of embodiment 5, further comprising training an artificial intelligence or machine learning model with the received feedback.
11. A method performed by a base station, the method comprising:
   receiving a mobility prediction report from another network node; and
   performing network optimization based on the mobility prediction report.
12. A method performed by a base station, the method comprising:
   a. any of the base station steps, features, or functions described above, either alone or in combination with other steps, features, or functions described above.
13. The method of the previous embodiments, further comprising one or more additional base station steps, features or functions described above.
14. The method of any of the previous embodiments, further comprising:
   obtaining user data; and
   forwarding the user data to a host computer or a wireless device.

### Group C Embodiments

15. A wireless device, the wireless device comprising:
   processing circuitry configured to perform any of the steps of any of the Group A embodiments; and
   power supply circuitry configured to supply power to the wireless device.
16. A base station, the base station comprising:
   processing circuitry configured to perform any of the steps of any of the Group B embodiments;
   power supply circuitry configured to supply power to the base station.
17. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
18. A computer program, the computer program comprising instructions which when executed on a computer perform any of the steps of any of the Group A embodiments.
19. A computer program product comprising a computer program, the computer program comprising instructions which when executed on a computer perform any of the steps of any of the Group A embodiments.
20. A non-transitory computer-readable storage medium or carrier comprising a computer program, the computer program comprising instructions which when executed on a computer perform any of the steps of any of the Group A embodiments.
21. A computer program, the computer program comprising instructions which when executed on a computer perform any of the steps of any of the Group B embodiments.
22. A computer program product comprising a computer program, the computer program comprising instructions which when executed on a computer perform any of the steps of any of the Group B embodiments.
23. A non-transitory computer-readable storage medium or carrier comprising a computer program, the computer program comprising instructions which when executed on a computer perform any of the steps of any of the Group B embodiments.
24. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
25. The communication system of the pervious embodiment further including the base station.
26. The communication system of the previous 2 embodiments, further including the UE, wherein the UE is configured to communicate with the base station.
27. The communication system of the previous 3 embodiments, wherein:
   the processing circuitry of the host computer is configured to execute a host application, thereby providing the user data; and
   the UE comprises processing circuitry configured to execute a client application associated with the host application.
28. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
29. The method of the previous embodiment, further comprising, at the base station, transmitting the user data.
30. The method of the previous 2 embodiments, wherein the user data is provided at the host computer by executing a host application, the method further comprising, at the UE, executing a client application associated with the host application.
31. A user equipment (UE) configured to communicate with a base station, the UE comprising a radio interface and processing circuitry configured to performs the of the previous 3 embodiments.
32. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
33. The communication system of the previous embodiment, wherein the cellular network further includes a base station configured to communicate with the UE.
34. The communication system of the previous 2 embodiments, wherein:
   the processing circuitry of the host computer is configured to execute a host application, thereby providing the user data; and
   the UE's processing circuitry is configured to execute a client application associated with the host application.
35. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
36. The method of the previous embodiment, further comprising at the UE, receiving the user data from the base station.
37. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
38. The communication system of the previous embodiment, further including the UE.
39. The communication system of the previous 2 embodiments, further including the base station, wherein the base station comprises a radio interface configured to communicate with the UE and a communication interface configured to forward to the host computer the user data carried by a transmission from the UE to the base station.
40. The communication system of the previous 3 embodiments, wherein:
   the processing circuitry of the host computer is configured to execute a host application; and
   the UE's processing circuitry is configured to execute a client application associated with the host application, thereby providing the user data.
41. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
42. A method implemented in a communication system including a host computer, a base station and a user equipment (UE), the method comprising:
   at the host computer, receiving user data transmitted to the base station from the UE, wherein the UE performs any of the steps of any of the Group A embodiments.
43. The method of the previous embodiment, further comprising, at the UE, providing the user data to the base station.
44. The method of the previous 2 embodiments, further comprising:
   at the UE, executing a client application, thereby providing the user data to be transmitted; and
   at the host computer, executing a host application associated with the client application.
45. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
46. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
47. The communication system of the previous embodiment further including the base station.
48. The communication system of the previous 2 embodiments, further including the UE, wherein the UE is configured to communicate with the base station.
49. The communication system of the previous 3 embodiments, wherein:
   the processing circuitry of the host computer is configured to execute a host application;
   the UE is configured to execute a client application associated with the host application, thereby providing the user data to be received by the host computer.
50. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
51. The method of the previous embodiment, further comprising at the base station, receiving the user data from the UE.
52. The method of the previous 2 embodiments, further comprising at the base station, initiating a transmission of the received user data to the host computer.
   Some additional example embodiments include the following:

1. A method performed by a first network node, the method comprising:
obtaining (1412) a user equipment, UE, trajectory prediction;
transmitting (1414) to a second network node the UE trajectory prediction and an indication requesting feedback regarding the UE trajectory prediction, wherein the indication requesting feedback comprises assistance information for associating an identifier with the requested feedback; and
receiving (1416) feedback regarding the UE trajectory prediction from a third network node based on the transmitted assistance information.

2. The method of claim 1, wherein the second network node and the third network node are the same network node.

3. The method of any one of claims 1-2, wherein the assistance information comprises an identifier for associating the requested feedback with the UE trajectory prediction.

4. The method of claim 3, wherein the identifier comprises an identifier of a UE.

5. The method of any one of claims 3-4, wherein the received feedback includes the identifier for associating the requested feedback with the UE trajectory prediction.

6. The method of any one of claims 1-5, wherein the assistance information comprises an identifier of a network node for receiving the feedback.

7 The method of any one of claims 1-6, wherein receiving the feedback comprises receiving an artificial intelligence/machine learning assistance data update message.

8 The method of any one of claims 1-7, wherein the assistance information comprises an indication that feedback is requested after a threshold number of handovers.

9 The method of any one of claims 1-8, wherein the received feedback comprises a list of UE trajectory cells.

10. The method of any one of claims 1-9, wherein the received feedback comprises a dwelling time for each cell of a list of UE trajectory cells.

11. The method of any one of claims 1-10, further comprising training an artificial intelligence or machine learning model with the received feedback.

12. A first network node (160) comprising processing circuitry (170) operable to:
obtain a user equipment, UE, trajectory prediction;
transmit to a second network node the UE trajectory prediction and an indication requesting feedback regarding the UE trajectory prediction, wherein the indication requesting feedback comprises assistance information for associating an identifier with the requested feedback; and
receive feedback regarding the UE trajectory prediction from a third network node based on the transmitted assistance information.

13. The network node of claim 12, the processing circuitry further operable to perform the steps of any one of claims 2-11.

14. A method performed by a second network node, the method comprising:
receiving (1512) a user equipment, UE, trajectory prediction and an indication requesting feedback regarding the UE trajectory prediction, wherein the indication requesting feedback comprises assistance information for associating an identifier with the requested feedback; and
transmitting (1514) feedback regarding the UE trajectory prediction to a first network node based on the assistance information.

15. The method of claim 14, wherein the first network node comprises a radio access network, RAN, node or an operations and management, OAM, node.

16. The method of any one of claims 14-15, wherein the assistance information comprises an identifier for associating the requested feedback with the UE trajectory prediction.

17. The method of claim 16, wherein the identifier comprises an identifier of a UE.

18. The method of any one of claims 16-17, wherein the transmitted feedback includes the identifier for associating the requested feedback with the UE trajectory prediction.

19. The method of any one of claims 14-18, wherein the assistance information comprises an identifier of a network node for transmitting the feedback.

20. The method of any one of claims 14-19, wherein transmitting the feedback comprises transmitting an artificial intelligence/machine learning assistance data update message.

21. The method of any one of claims 14-20, wherein the assistance information comprises an indication that feedback is requested after a threshold number of handovers.

22. The method of any one of claims 14-21, wherein the transmitted feedback comprises a list of UE trajectory cells.

23. The method of any one of claims 14-22, wherein the transmitted feedback comprises a dwelling time for each cell of a list of UE trajectory cells.

24. A second network node (160) comprising processing circuitry (170) operable to:
receive a user equipment, UE, trajectory prediction along with an indication requesting feedback regarding the UE trajectory prediction; and
transmit feedback regarding the UE trajectory prediction to a first network node.

25. The network node of claim 24, the processing circuitry further operable to perform the steps of any one of claims 15-23.

### APPENDIX A

### Title: Cell Trajectory Prediction Exchange

### 1 Introduction

The use and semantics of the UE trajectory prediction for AI/ML was discussed during RAN3 #117-e, and the following agreement was captured

Predicted cell-granularity UE trajectory can be exchanged over Xn for AI/ML based mobility optimization.

This was further discussed during RAN3 #117bis-e and the following were agreed:

Cell-based UE Trajectory prediction has the same structure as UE History Information IE.

Cell-based UE Trajectory prediction is provided as a list of cells into the future, each of which is indicated together with an expected time of stay into the cell.

This Appendix aims at discussing the next steps related to standard impact of the above agreements, and at further discussing the open issue listed above.

### 2 Discussion

### 2.1 Cell-Based UE Trajectory Prediction Information

Now that the Cell-based UE trajectory prediction has been agreed, RAN3 needs to define the information it contains. It was already agreed that:

Cell-based UE Trajectory prediction has the same structure as UE History Information IE.

Cell-based UE Trajectory prediction is provided as a list of cells into the future, each of which is indicated together with an expected time of stay into the cell.

Regarding the UHI IE (Last Visited NG-RAN Cell Information IE from TS 38.413), for each cell or set of cells, it contains the following information:
1. Cell ID (as mandatory)
2. Cell Type (as mandatory)
3. Time UE Stayed in Cell (as mandatory)
4. Time UE Stayed in Cell Enhanced Granularity (as optional)
5. HO Cause Value (as optional)

For Cell-based UE Trajectory prediction, (1) and (3) have already been agreed during previous meetings.

Observation 1: Cell ID and Expected Time of Stay have Already been Agreed to be Included as Cell-Based UE Trajectory Prediction

(2) is not always known at the node performing the prediction, because the prediction may include cells which are not neighbors to the node computing the prediction. Configuring this information for all the cells, including the ones which are not neighboring cells, will be a burden for the operator. Therefore, and even though this information might be interesting for the prediction itself, it is proposed not to add it to the Cell-based UE Trajectory prediction information.

### Observation 2: Configuring Cell Type for the Non-Neighboring Cells Will be a Burden for the Operator

For trajectory predictions, a granularity of 100 ms, as proposed with (4), is too detailed to result in accurate prediction. It would also not be very useful to the node receiving the prediction. If the prediction is used to help predicting mobility, relying on the exact time of the prediction to trigger HO or configure measurements may lead to an increase of HOF or RLF. The final HO decision shall always be taken based on actual radio conditions. If the prediction is used for ES scenarios, one second granularity is sufficient. Therefore, it is proposed not to add the enhanced granularity IE to the Cell-based UE Trajectory prediction information.

### Observation 3: 100 ms Granularity for Accurate Trajectory Prediction is Too Complex and not Useful to the Node Receiving the Prediction

Finally, (5) is not an information related to a trajectory, and cannot be predicted accurately, as the decision to handover a UE (and therefore the HO cause) will be taken by a node different from the node performing the prediction. Therefore, it is proposed not to add HO cause to the Cell-based UE Trajectory prediction information.

### Observation 4: HO Cause is not Related to a Trajectory

To conclude, it is proposed to agree that the Cell Trajectory Prediction IE contains a list of predicted cells, in chronological order, including the following information:
Global Cell ID
Predicted Time UE Stays in Cell

Proposal 1: Cell Trajectory Prediction is signaled as a list of predicted cell IDs the UE will connect to, in chronological order, together with the time the UE is expected to stay in this cell

Proposal 2: Cell type, expected time of stay enhanced granularity and HO cause are not needed as Cell-based UE Trajectory prediction information

The remaining question is how to signal this information to the node needing the trajectory prediction. Handover decisions are taken on a UE basis, mainly for coverage reasons, and based on UE measurements and capabilities. These parameters being different for different UEs, it is logical to conclude that the cell-based UE trajectory prediction is associated to a given UE, as for UHI. It is therefore proposed that UE-associated signaling is used to signal Cell Trajectory Prediction.

Proposal 3: Cell Trajectory Prediction is signaled via UE-associated signaling

If the goal of the cell-based UE trajectory prediction is to give more information to the source and target nodes to optimize mobility, and if UE-associated signaling is used, the next logical conclusion would be to reuse the Handover Request message, like with UHI signaling.

Cell based UE Trajectory Prediction is transferred via existing HO signaling messages.

Proposal 4: Cell Trajectory Prediction is signaled in Handover Request message

### 2.2 Feedback for Cell-Based UE Trajectory Prediction

A discussion on UE trajectory prediction feedback was triggered at RAN3 #117bis-e. Some companies proposed that an actual measurement of a trajectory prediction is signaled to a source RAN node in order to serve as feedback information to improve future predictions.

To determine whether this approach is feasible it needs to be highlighted that an NG-RAN node produces a trajectory prediction on a per UE basis. Namely, the model inference function would take as an input past mobility of the UE, UE location, UE radio measurements (e.g., leading to direction of movement), etc., and it will derive a prediction of trajectory for the specific UE. With this in mind, the following issues can be immediately determined when analyzing the option of receiving measured trajectories as feedback:
After UE mobility the source NG-RAN removes the UE context. Hence, even if the NG-RAN node received a measured UE trajectory, it would not be able to determine to what UE context the feedback corresponds to. This makes the feedback rather useless, as it is not possible to associate the feedback with the prediction it corresponds to.
If a trajectory prediction covers the n future cell hops, it is very likely that the NG-RAN node serving the n^{th} cell will not be Xn connected to the source node that produced the prediction. Hence, even if the source node kept the UE context stored, there would be likely no way the n^{th} NG-RAN node could signal the trajectory feedback back.
By the time a measured prediction is made available to the source node, the layout of cells in a neighborhood might have changed. As an example, some cells that were active when the prediction was produced may become deactivated. In order for the source node to properly understand the trajectory feedback, the source node would need to keep a full history of how the cell deployment has changed in time, which increases complexity as it requires to maintain a full context of cell deployment status at the NG-RAN node

Given the issues above, it can be concluded that signaling of trajectory feedback is not feasible.

Instead, the source NG-RAN node may use the UE history information to check on the correctness of its trajectory predictions. In fact, UEs trajectories are often recurrent. Namely a UE is likely to go through the same route often. By means of checking the UE History Information, an NG-RAN node is able to see the mobility history of a UE that was previously served by the NG-RAN node and that is going back to it. Such history may serve as feedback for future predictions. The table below explains this concept.

| UE Trajectory prediction for | Measured UHI for |
|---|---|
| UE x while in Cell1 | UE y connected to Cell1 |
| t₀ - CGI 1 | t₀ - CGI1 |
| t₁ - CGI 2 | t₋₁ - CGI4 |
| t₂ - CGI 1 | t₋₂ - CGI3 |
| t₃ - CGI 3 | t₋₃ - CGI1 |
| t₄ - CGI 4 | t₋₄ - CGI2 |

In the table above, NG-RAN node 1 predicted the UE trajectory for UE x connected to Cell1. At the same time UE y connects to Cell 1 and NG-RAN node 1 receives the UE History Information in the right column.

It is possible for NG-RAN node 1 to see that the sequence of historical cells the newly connected UE went through matches well with a trajectory prediction NG-RAN node 1 derived for a UE in similar conditions.

Given that an NG-RAN node receives thousands of UHI per day, it is plausible to think that UHIs can have statistical relevance with time and therefore serve as trajectory feedback.

Conclusion: Explicit signaling to a source NG-RAN of a measured UE trajectory is not feasible. An NG-RAN node can make use of UE History Information to derive feedback for UE trajectory predictions

### APPENDIX B

An example of an updated specification based on the embodiments and examples described herein may include the following.

### 1^{st} Change

### 8.2.1 Handover Preparation

### 8.2.1.1 General

This procedure is used to establish necessary resources in an NG-RAN node for an incoming handover. If the procedure concerns a conditional handover, parallel transactions are allowed. Possible parallel requests are identified by the target cell ID when the source UE AP IDs are the same.

The procedure uses UE-associated signaling.

### 8.2.1.2 Successful Operation

### <Figure Omitted>

### FIG. 8.2.1.2-1: Handover Preparation, Successful Operation

The source NG-RAN node initiates the procedure by sending the HANDOVER REQUEST message to the target NG-RAN node. When the source NG-RAN node sends the HANDOVER REQUEST message, it shall start the timer TXnRELOCprep.

If the Conditional Handover Information Request IE is contained in the HANDOVER REQUEST message, the target NG-RAN node shall consider that the request concerns a conditional handover and shall include the Conditional Handover Information Acknowledge IE in the HANDOVER REQUEST ACKNOWLEDGE message.

If the Target NG-RAN node UE XnAP ID IE is contained in the Conditional Handover Information Request IE included in the HANDOVER REQUEST message, then the target NG-RAN node shall remove the existing prepared conditional HO identified by the Target NG-RAN node UE XnAP ID IE and the Target Cell Global ID IE. It is up to the implementation of the target NG-RAN node when to remove the HO information.

Upon reception of the HANDOVER REQUEST ACKNOWLEDGE message, the source NG-RAN node shall stop the timer TXnRELOCprep and terminate the Handover Preparation procedure. If the procedure was initiated for an immediate handover, the source NG-RAN node shall start the timer TXn_{RELOCoverall}. The source NG-RAN node is then defined to have a Prepared Handover for that Xn UE-associated signalling.

For each E-RAB ID IE included in the QoS Flow To Be Setup List IE in the HANDOVER REQUEST message, the target NG-RAN node shall, if supported, store the content of the IE in the UE context and use it for subsequent inter-system handover.

If the Masked IMEISV IE is contained in the HANDOVER REQUEST message the target NG-RAN node shall, if supported, use it to determine the characteristics of the UE for subsequent handling.

At reception of the HANDOVER REQUEST message the target NG-RAN node shall prepare the configuration of the AS security relation between the UE and the target NG-RAN node by using the information in the UE Security Capabilities IE and the AS Security Information IE in the UE Context Information IE, as specified in TS 33.501.

Upon reception of the PDU Session Resource Setup List IE, contained in the HANDOVER REQUEST message, the target NG-RAN node shall behave the same as specified in TS 38.413 for the PDU Session Resource Setup procedure. The target NG-RAN node shall report in the HANDOVER REQUEST ACKNOWLEDGE message the successful establishment of the result for all the requested PDU session resources. When the target NG-RAN node reports the unsuccessful establishment of a PDU session resource, the cause value should be precise enough to enable the source NG-RAN node to know the reason for the unsuccessful establishment.

For each PDU session if the PDU Session Aggregate Maximum Bit Rate IE is included in the PDU Session Resources To Be Setup List IE contained in the HANDOVER REQUEST message, the target NG-RAN node shall store the received PDU Session Aggregate Maximum Bit Rate in the UE context and use it when enforcing traffic policing for Non-GBR QoS flows for the concerned UE as specified in TS 23.501.

For each QoS flow for which the source NG-RAN node proposes to perform forwarding of downlink data, the source NG-RAN node shall include the DL Forwarding IE set to “DL forwarding proposed” within the Data Forwarding and Offloading Info from source NG-RAN node IE in the PDU Session Resources To Be Setup List IE in the HANDOVER REQUEST message. The source NG-RAN node shall include the DL Forwarding IE set to “DL forwarding proposed” for all the QoS flows mapped to a DRB, if it requests a DAPS handover for that DRB. For each PDU session that the target NG-RAN node decides to admit the data forwarding for at least one QoS flow, the target NG-RAN node includes the PDU Session level DL data forwarding GTP-U Tunnel Endpoint IE within the Data Forwarding Info from target NG-RAN node IE in the PDU Session Resource Admitted Info IE contained in the PDU Session Resources Admitted List IE in the HANDOVER REQUEST ACKNOWLEDGE message.

For each QoS flow for which the source NG-RAN node has not yet received the SDAP end marker packet if QoS flow re-mapping happened before handover, the source NG-RAN node shall include the UL Forwarding Proposal IE within the Data Forwarding and Offloading Info from source NG-RAN node IE in the HANDOVER REQUEST message, and if the target NG-RAN node decides to admit uplink data forwarding for at least one QoS flow, the target NG-RAN node may include the PDU Session Level UL Data Forwarding UP TNL Information IE in the Data Forwarding Info from target NG-RAN node IE in the PDU Session Resources Admitted Item IE contained in the PDU Session Resources Admitted List IE in the HANDOVER REQUEST ACKNOWLEDGE message to indicate that it accepts the uplink data forwarding.

For each PDU session resource successfully setup at the target NG-RAN, the target NG-RAN node may allocate resources for additional Xn-U PDU session resource GTP-U tunnels, indicated in the Secondary Data Forwarding Info from target NG-RAN node List IE.

For each PDU session in the HANDOVER REQUEST message, if the Alternative QoS Parameters Set List IE is included in the GBR QoS Flow Information IE in the PDU Session Resources To Be Setup List IE, the target NG-RAN node may accept the setup of the involved QoS flow when notification control has been enabled if the requested QoS parameters set or at least one of the alternative QoS parameters sets can be fulfilled at the time of handover as specified in TS 23.501. In case the target NG-RAN node accepts the handover fulfilling one of the alternative QoS parameters it shall indicate the alternative QoS parameters set which it can currently fulfil in the Current QoS Parameters Set Index IE within the PDU Session Resources Admitted List IE of the HANDOVER REQUEST ACKNOWLEDGE message while setting the QoS parameters towards the UE according to the requested QoS parameters set as specified in TS 23.501.

For each DRB for which the source NG-RAN node proposes to perform forwarding of downlink data, the source NG-RAN node shall include the DRB ID IE and the mapped QoS Flows List IE within the Source DRB to QoS Flow Mapping List IE contained in the PDU Session Resources To Be Setup List IE in the HANDOVER REQUEST message. The source NG-RAN node may include the QoS Flow Mapping Indication IE in the Source DRB to QoS Flow Mapping List IE to indicate that only the uplink or downlink QoS flow is mapped to the DRB. If the target NG-RAN node decides to use the same DRB configuration and to map the same QoS flows as the source NG-RAN node, the target NG-RAN node includes the DL Forwarding GTP Tunnel Endpoint IE within the Data Forwarding Response DRB List IE in the HANDOVER REQUEST ACKNOWLEDGE message to indicate that it accepts the proposed forwarding of downlink data for this DRB.

The target NG-RAN node may additionally include the Redundant DL Forwarding UP TNL Information IE if at least one of the QoS flow mapped to the DRB is eligible to the redundant transmission feature as indicated in the Redundant QoS Flow Indicator IE within the PDU Session Resource To Be Setup List IE received in the HANDOVER REQUEST message for the QoS flow.

If the HANDOVER REQUEST ACKNOWLEDGE message contains the UL Forwarding GTP Tunnel Endpoint IE for a given DRB in the Data Forwarding Response DRB List IE within Data Forwarding Info from target NG-RAN node IE in the PDU Session Resources Admitted List IE and the source NG-RAN node accepts the data forwarding proposed by the target NG-RAN node, the source NG-RAN node shall perform forwarding of uplink data for the DRB.

If the HANDOVER REQUEST includes PDU session resources for PDU sessions associated to S-NSSAIs not supported by target NG-RAN, the target NG-RAN node shall reject such PDU session resources. In this case, and if at least one PDU Session Resource To Be Setup Item IE is admitted, the target NG-RAN node shall send the HANDOVER REQUEST ACKNOWLEDGE message including the PDU Session Resources Not Admitted List IE listing corresponding PDU sessions rejected at the target NG-RAN.

If the Mobility Restriction List IE is
contained in the HANDOVER REQUEST message, the target NG-RAN node shall
   store the information received in the Mobility Restriction List IE in the UE context;
   use this information to determine a target for the UE during subsequent mobility action for which the NG-RAN node provides information about the target of the mobility action towards the UE, except when one of the PDU sessions has a particular ARP value (TS 23.501) in which case the information shall not apply;
   use this information to select a proper SCG during dual connectivity operation.
   use this information to select proper RNA(s) for the UE when moving the UE to RRC_INACTIVE.
not contained in the HANDOVER REQUEST message, the target NG-RAN node shall
   consider that no roaming and no access restriction apply to the UE.

If the Trace Activation IE is included in the HANDOVER REQUEST message the target NG-RAN node shall, if supported, initiate the requested trace function as specified in TS32.422 (e.g. v17.8.0).

If the Index to RAT Frequency Selection Priority IE is contained in the HANDOVER REQUEST message, the target NG-RAN node shall store this information and use it as defined in TS 23.501.

If the UE Context Reference at the S-NG-RAN IE is contained in the HANDOVER REQUEST message the target NG-RAN node may use it as specified in TS 37.340 (e.g. v17.2.0). In this case, the source NG-RAN node may expect the target NG-RAN node to include the UE Context Kept Indicator IE set to “True” in the HANDOVER REQUEST ACKNOWLEDGE message, which shall use this information as specified in TS 37.340.

For each PDU session, if the Network Instance IE is included in the PDU Session Resource To Be Setup List IE and the Common Network Instance IE is not present, the target NG-RAN node shall, if supported, use it when selecting transport network resource as specified in TS 23.501.

### Redundant Transmission:

For each PDU session, if the Redundant UL NG-U UP TNL Information at UPF IE is included in the PDU Session Resource To Be Setup List IE, the target NG-RAN node shall, if supported, use it as the uplink termination point for the user plane data for the redundant transmission for the concerned PDU session.
For each PDU session, if the Additional Redundant UL NG-U UP TNL Information at UPF List IE is included in the PDU Session Resource To Be Setup List IE, the target NG-RAN node shall, if supported, use them as the uplink termination points for the user plane data for the redundant transmission for the concerned PDU session.
For each PDU session, if the Redundant Common Network Instance IE is included in the PDU Session Resource To Be Setup List IE, the target NG-RAN node shall, if supported, use it when selecting transport network resource for the redundant transmission as specified in TS 23.501.
For each PDU session, if the Redundant PDU Session Information IE is included in the PDU Session Resource To Be Setup List IE contained in the HANDOVER REQUEST message, the target NG-RAN node shall, if supported, store the received information in the UE context and set up the redundant user plane for the concerned PDU session, as specified in TS 23.501. If the PDU Session Pair ID IE is included in the Redundant PDU Session Information IE, the target NG-RAN node may store and use it to identify the paired PDU sessions.

If the TSC Traffic Characteristics IE is included in the QoS Flows To Be Setup List in the PDU Session Resource To Be Setup List IE, the target NG-RAN node shall, if supported, use it as specified in TS 23.501.

For each PDU session, if the Common Network Instance IE is included in the PDU Session Resource To Be Setup List IE or in the Additional UL NG-U UP TNL Information at UPF List IE, or in the Additional Redundant UL NG-U UP TNL Information at UPF List IE, the target NG-RAN node shall, if supported, use it when selecting transport network resource for the concerned NG-U transport bearer as specified in TS 23.501.

For each PDU session for which the Security Indication IE is included in the PDU Session Resource To Be Setup List IE and the Integrity Protection Indication IE or Confidentiality Protection Indication IE is set to “required”, the target NG-RAN node shall perform user plane integrity protection or ciphering, respectively. If the NG-RAN node is not able to perform the user plane integrity protection or ciphering, it shall reject the setup of the PDU Session Resources with an appropriate cause value.

If the NG-RAN node is an ng-eNB, it shall reject all PDU sessions for which the Integrity Protection Indication IE is set to “required”.

For each PDU session for which the Security Indication IE is included in the PDU Session Resource To Be Setup List IE and the Integrity Protection Indication IE or the Confidentiality Protection Indication IE is set to “preferred”, the target NG-RAN node should, if supported, perform user plane integrity protection or ciphering, respectively and shall notify the SMF whether it succeeded the user plane integrity protection or ciphering or not for the concerned security policy.

For each PDU session for which the Maximum Integrity Protected Data Rate IE is included in the Security Indication IE in the PDU Session Resources To Be Setup List IE, the NG-RAN node shall store the respective information and, if integrity protection is to be performed for the PDU session, it shall enforce the traffic corresponding to the received Maximum Integrity Protected Data Rate IE, for the concerned PDU session and concerned UE, as specified in TS 23.501.

For each PDU session for which the Security Indication IE is included in the PDU Session Resource To Be Setup List IE and the Integrity Protection Indication IE or Confidentiality Protection Indication IE is set to “not needed”, the target NG-RAN node shall not perform user plane integrity protection or ciphering, respectively, for the concerned PDU session.

For each PDU session, if the Additional UL NG-U UP TNL Information List IE is included in the PDU Session Resources To Be Setup List IE contained in the HANDOVER REQUEST message, the target NG-RAN node may forward the UP transport layer information to the target S-NG-RAN node as the uplink termination point for the user plane data for this PDU session split in different tunnel.

If the Location Reporting Information IE is included in the HANDOVER REQUEST message, then the target NG-RAN node should initiate the requested location reporting functionality as defined in TS 38.413.

Upon reception of UE History Information IE in the HANDOVER REQUEST message, the target NG-RAN node shall collect the information defined as mandatory in the UE History Information IE and shall, if supported, collect the information defined as optional in the UE History Information IE, for as long as the UE stays in one of its cells, and store the collected information to be used for future handover preparations.

If the Trace Activation IE is included in the HANDOVER REQUEST message which includes
the MDT Activation IE set to “Immediate MDT and Trace”, then the target NG-RAN node shall if supported, initiate the requested trace session and MDT session as described in TS 32.422.
the MDT Activation IE set to “Immediate MDT Only” or “Logged MDT only”, the target NG-RAN node shall, if supported, initiate the requested MDT session as described in TS 32.422 and the target NG-RAN node shall ignore the Interfaces To Trace IE, and the Trace Depth IE.
the MDT Location Information IE, within the MDT Configuration IE, the target NG-RAN node shall, if supported, store this information and take it into account in the requested MDT session.
the MDT Activation IE set to “Immediate MDT Only” or “Logged MDT only”, and if the Signalling based MDT PLMN List IE is included in the MDT Configuration IE, the target NG-RAN node may use it to propagate the MDT Configuration as described in TS 37.320 (e.g. v17.1.0).
the Bluetooth Measurement Configuration IE, within the MDT Configuration IE, the target NG-RAN node shall, if supported, take it into account for MDT Configuration as described in TS 37.320.
the WLAN Measurement Configuration IE, within the MDT Configuration IE, the target NG-RAN node shall, if supported, take it into account for MDT Configuration as described in TS 37.320.
the Sensor Measurement Configuration IE, within the MDT Configuration IE, the target NG-RAN node shall take it into account for MDT Configuration as described in TS 37.320.
the MDT Configuration IE and if the target NG-RAN node is a gNB receiving a MDT Configuration-EUTRA IE, or the target NG-RAN node is a ng-eNB receiving a MDT Configuration-NR IE, the target NG-RAN node shall store it as part of the UE context, and use it as described in TS 37.320.

If the Management Based MDT PLMN List IE is contained in the HANDOVER REQUEST message, the target NG-RAN node shall, if supported, store the received information in the UE context, and use this information to allow subsequent selection of the UE for management based MDT defined in TS 32.422.

If the HANDOVER REQUEST message includes the Management Based MDT PLMN List IE, the target NG-RAN node shall, if supported, store it in the UE context, and take it into account if it includes information regarding the PLMN serving the UE in the target NG-RAN node.

If the Mobility Information IE is provided in the HANDOVER REQUEST message, the target NG-RAN node shall, if supported, store this information. The target NG-RAN shall, if supported, store the C-RNTI assigned at the source cell as received in the HANDOVER REQUEST message.

Upon reception of the UE History Information from the UE IE in the HANDOVER REQUEST message, the target NG-RAN node shall, if supported, store the collected information and use it for future handover preparations.

For each QoS flow which has been successfully established in the target NG-RAN node, if the QoS Monitoring Request IE was included in the QoS Flow Level QoS Parameters IE contained in the HANDOVER REQUEST message, the target NG-RAN node shall store this information, and shall, if supported, perform delay measurement and QoS monitoring, as specified in TS 23.501. If the QoS Monitoring Reporting Frequency IE was included in the QoS Flow Level QoS Parameters IE contained in the HANDOVER REQUEST message, the target NG-RAN node shall store this information, and shall, if supported, use it for RAN part delay reporting.

If the 5GC Mobility Restriction List Container IE is included in the HANDOVER REQUEST message, the target NG-RAN node shall, if supported, store this information in the UE context and use it as specified in TS 38.300 (e.g. v17.2.0).

### V2X:

If the NR V2X Services Authorized IE is included in the HANDOVER REQUEST message and it contains one or more IEs set to “authorized”, the target NG-RAN node shall, if supported, consider that the UE is authorized for the relevant service(s).
If the LTE V2X Services Authorized IE is included in the HANDOVER REQUEST message and it contains one or more IEs set to “authorized”, the target NG-RAN node shall, if supported, consider that the UE is authorized for the relevant service(s).
If the NR UE Sidelink Aggregate Maximum Bit Rate IE is included in the HANDOVER REQUEST message, the target NG-RAN node shall, if supported, use the received value for the concerned UE's sidelink communication in network scheduled mode for NR V2X services.
If the LTE UE Sidelink Aggregate Maximum Bit Rate IE is included in the HANDOVER REQUEST message, the target NG-RAN node shall, if supported, use the received value for the concerned UE's sidelink communication in network scheduled mode for LTE V2X services.

### 5G ProSe:

If the 5G ProSe Authorized IE is included in the HANDOVER REQUEST message and it contains one or more IEs set to “authorized”, the target NG-RAN node shall, if supported, consider that the UE is authorized for the relevant service(s).
If the 5G ProSe UE PC5 Aggregate Maximum Bit Rate IE is included in the HANDOVER REQUEST message, the target NG-RAN node shall, if supported, use the received value for the concerned UE's sidelink communication in network scheduled mode for 5G ProSe services.
If the 5G ProSe PC5 QoS Parameters IE is included in the HANDOVER REQUEST message, the target NG-RAN node shall, if supported, use it as defined in TS 23.304 (e.g. v17.4.0).

If the PC5 QoS Parameters IE is included in the HANDOVER REQUEST message, the target NG-RAN node shall, if supported, use it as defined in TS 23.287 (e.g. v17.4.0).

If the DAPS Request Information IE is included for a given DRB in the HANDOVER REQUEST message, the target NG-RAN node shall consider that the request concerns a DAPS handover for that DRB, as described in TS 38.300. Accordingly, the target NG-RAN node shall include the DAPS Response Information IE in the HANDOVER REQUEST ACKNOWLEDGE message.

If the Maximum Number of CHO Preparations IE is included in the Conditional Handover Information Acknowledge IE contained in the HANDOVER REQUEST ACKNOWLEDGE message, then the source NG-RAN node should not prepare more candidate target cells for a CHO for the same UE towards the target NG-RAN node than the number indicated in the IE.

If the Estimated Arrival Probability IE is contained in the Conditional Handover Information Request IE included in the HANDOVER REQUEST message, then the target NG-RAN node may use the information to allocate necessary resources for the incoming CHO.

If the LAB Node Indication IE is contained in the HANDOVER REQUEST message, the target NG-RAN node shall, if supported, consider that the handover is for an IAB node. In addition:
If the No PDU Session Indication IE is contained in the HANDOVER REQUEST message, the target NG-RAN node shall, if supported, consider the UE as an IAB-node which does not have any PDU sessions activated, and ignore the PDU Session Resources To Be Setup List IE, and shall not take any action with respect to PDU session setup. Subsequently, the source NG-RAN node shall, if supported, ignore the PDU Session Resources Admitted To Be Added List IE in the HANDOVER REQUEST ACKNOWLEDGE message.

If the UE Radio Capability ID IE is contained in the HANDOVER REQUEST message, the target NG-RAN node shall, if supported, store this information in the UE context and use it as defined in TS 23.501 and TS 23.502 (e.g. v17.6.0).

If for a given QoS Flow the Source DL Forwarding IP Address IE is included within the Data Forwarding and Offloading Info from source NG-RAN node IE in the PDU Session Resources To Be Setup List IE contained in the HANDOVER REQUEST message, the target NG-RAN node shall, if supported, store this information and use it as part of its ACL functionality configuration actions, if such ACL functionality is deployed.

If the MBS Session Information List IE is contained in the HANDOVER REQUEST message, the target NG-RAN node shall, if supported, establish MBS session resources as specified in TS 23.247 (e.g. v17.4.0) and TS 38.300, if applicable.

If the HANDOVER REQUEST message includes the MBS Area Session ID IE, the target NG-RAN, if supported, shall use this information as an indication from which MBS Area Session ID the UE is handed over. For each MBS session for which the Active MBS Session Information IE is included in the MBS Session Information Item List IE, the target NG-RAN shall, if supported, use this information to setup respective MBS Session Resources. The target NG-RAN node shall, if supported, consider that the MBS sessions for which the Active MBS Session Information IE is not included are inactive.

If the HANDOVER REQUEST ACKNOWLEDGE message contains in the MBS Session Information Response List IE the MBS Data Forwarding Response Info IE that the source NG-RAN node shall use the information for forwarding MBS traffic to the target NG-RAN node.

If the MBS Session Associated Information List IE is included in the PDU Session Resources To Be Setup List IE in the HANDOVER REQUEST message, the target NG-RAN node shall, if supported, use the information contained in the Associated QoS Flows Information List IE as specified in TS 23.247.

For each MRB indicated in the MBS Mapping and Data Forwarding Request Info from source NG-RAN node IE, the target NG-RAN node shall use the MRB ID IE and, if included, the MRB Progress Information IE which includes the highest PDCP SN of the packet which has already been delivered to the UE for the MRB, to decide whether to apply data forwarding for that MRB and to establish respective resources.

The source NG-RAN shall, for each MRB in the MBS Data Forwarding Response Info from target NG-RAN node IE in the HANDOVER REQUEST ACKNOWLEDGE message, start data forwarding to the indicated DL Forwarding UP TNL Information. If the MRB Progress Information IE is included the source NG-RAN node may use the information to determine when to stop data forwarding.

If the Time Synchronisation Assistance Information IE is contained in the HANDOVER REQUEST message, the target NG-RAN node shall, if supported, store this information in the UE context and use it as defined in TS 23.501.

If the QMC Configuration Information IE is contained in the HANDOVER REQUEST message, the target NG-RAN node shall, if supported, take it into account for QoE measurements handling, as described in TS 38.300.

If the UE Slice-Maximum Bit Rate List IE is contained in HANDOVER REQUEST message, the target NG-RAN node shall, if supported, store the received UE Slice Maximum Bit Rate List in the UE context, and use the received UE Slice Maximum Bit Rate value for each S-NSSAI for the concerned UE as specified in TS 23.501.

If the Cell Trajectory Prediction IE is contained in the HANDOVER REQUEST message, the target NG-RAN node considers the content of this list as the cell trajectory predicted by the source NG-RAN node, and may use it for e.g., mobility decisions.

Interaction with SN Status Transfer Procedure:

If the UE Context Kept Indicator IE set to “True” and the DRBs transferred to MN IE are included in the HANDOVER REQUEST ACKNOWLEDGE message, the source NG-RAN node shall, if supported, include the uplink/downlink PDCP SN and HFN status received from the S-NG-RAN node in the SN Status Transfer procedure towards the target NG-RAN node, as specified in TS 37.340.

### 8.2.1.3 Unsuccessful Operation

### <Figure Omitted>

### FIG. 8.2.1.3-1: Handover Preparation, Unsuccessful Operation

If the target NG-RAN node does not admit at least one PDU session resource, or a failure occurs during the Handover Preparation, the target NG-RAN node shall send the HANDOVER PREPARATION FAILURE message to the source NG-RAN node. The message shall contain the Cause IE with an appropriate value.

If the Conditional Handover Information Request IE is contained in the HANDOVER REQUEST message and the target NG-RAN node rejects the handover or a failure occurs during the Handover Preparation, the target NG-RAN node shall include the Requested Target Cell ID IE in the HANDOVER PREPARATION FAILURE message.

Interactions with Handover Cancel Procedure:

If there is no response from the target NG-RAN node to the HANDOVER REQUEST message before timer TXnRELOCprep expires in the source NG-RAN node, the source NG-RAN node should cancel the Handover Preparation procedure towards the target NG-RAN node by initiating the Handover Cancel procedure with the appropriate value for the Cause IE. The source NG-RAN node shall ignore any HANDOVER REQUEST ACKNOWLEDGE or HANDOVER PREPARATION FAILURE message received after the initiation of the Handover Cancel procedure and remove any reference and release any resources related to the concerned Xn UE-associated signaling.

### 8.2.1.4 Abnormal Conditions

If the supported algorithms for encryption defined in the UE Security Capabilities IE in the UE Context Information IE, plus the mandated support of the EEA0 and NEA0 algorithms in all UEs (TS 33.501), do not match any allowed algorithms defined in the configured list of allowed encryption algorithms in the NG-RAN node (TS 33.501), the NG-RAN node shall reject the procedure using the HANDOVER PREPARATION FAILURE message.

If the supported algorithms for integrity defined in the UE Security Capabilities IE in the UE Context Information IE, plus the mandated support of the EIA0 and NIA0 algorithms in all UEs (TS 33.501), do not match any allowed algorithms defined in the configured list of allowed integrity protection algorithms in the NG-RAN node (TS 33.501), the NG-RAN node shall reject the procedure using the HANDOVER PREPARATION FAILURE message.

If the CHO trigger IE is set to “CHO-replace” in the HANDOVER REQUEST message, but there is no CHO prepared for the included Target NG-RAN node UE XnAP ID, or the candidate cell in the Target Cell ID IE was not prepared using the same UE-associated signaling connection, the NG-RAN node shall reject the procedure using the HANDOVER PREPARATION FAILURE message.

If the HANDOVER REQUEST message includes information for a PLMN not serving the UE in the target NG-RAN node in the Management Based MDT PLMN List IE, the target NG-RAN node shall ignore information for that PLMN within the Management Based MDT PLMN List.

### End of 1^{st} Change

——TEXT OMITTED——

### 2^{nd} Change

### 9.1.1.1 Handover Request

This message is sent by the source NG-RAN node to the target NG-RAN node to request the preparation of resources for a handover.

Direction: source NG-RAN node→target NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Source NG-RAN node UE | M | | NG-RAN | Allocated at the | YES | reject |
| XnAP ID reference | | | node UE | source NG-RAN | | |
| | | | XnAP ID | node | | |
| | | | 9.2.3.16 | | | |
| Cause | M | | 9.2.3.2 | | YES | reject |
| Target Cell Global ID | M | | 9.2.3.25 | Includes either an | YES | reject |
| | | | | E-UTRA CGI or an | | |
| | | | | NR CGI | | |
| GUAMI | M | | 9.2.3.24 | | YES | reject |
| UE Context Information | | 1 | | | YES | reject |
| >NG-C UE associated | M | | AMF UE | Allocated at the | — | |
| Signalling reference | | | NGAP ID | AMF on the source | | |
| | | | 9.2.3.26 | NG-C connection. | | |
| >Signalling TNL association | M | | CP | This IE indicates | — | |
| address at source NG-C | | | Transport | the AMF's IP | | |
| side | | | Layer | address of the | | |
| | | | Information | SCTP association | | |
| | | | 9.2.3.31 | used at the source | | |
| | | | | NG-C interface | | |
| | | | | instance. | | |
| | | | | Note: | | |
| | | | | If no UE | | |
| | | | | TNLA binding | | |
| | | | | exists at the source | | |
| | | | | NG-RAN node, the | | |
| | | | | source NG-RAN | | |
| | | | | node indicates the | | |
| | | | | TNL association | | |
| | | | | address it would | | |
| | | | | have selected if it | | |
| | | | | would have had to | | |
| | | | | create a UE TNLA | | |
| | | | | binding. | | |
| >UE Security Capabilities | M | | 9.2.3.49 | | — | |
| >AS Security Information | M | | 9.2.3.50 | | — | |
| >Index to RAT/Frequency | O | | 9.2.3.23 | | — | |
| Selection Priority | | | | | | |
| >UE Aggregate Maximum | M | | 9.2.3.17 | | — | |
| Bit Rate | | | | | | |
| >PDU Session Resources | | 1 | 9.2.1.1 | Similar to NG-C | — | |
| To Be Setup List | | | | signalling, | | |
| | | | | containing UL | | |
| | | | | tunnel information | | |
| | | | | per PDU Session | | |
| | | | | Resource; | | |
| | | | | and in addition, the | | |
| | | | | source side QoS | | |
| | | | | flow ⇔ DRB | | |
| | | | | mapping | | |
| >RRC Context | M | | OCTET | Either includes the | — | |
| | | | STRING | HandoverPrepara- | | |
| | | | | tionInformation | | |
| | | | | message as | | |
| | | | | defined in | | |
| | | | | subclause 10.2.2. | | |
| | | | | of TS 36.331, or | | |
| | | | | the | | |
| | | | | HandoverPrepara- | | |
| | | | | tionInformation-NB | | |
| | | | | message as | | |
| | | | | defined in | | |
| | | | | subclause 10.6.2 of | | |
| | | | | TS 36.331, if the | | |
| | | | | target NG-RAN | | |
| | | | | node is an ng-eNB, | | |
| | | | | or the | | |
| | | | | HandoverPrepara- | | |
| | | | | tionInformation | | |
| | | | | message as | | |
| | | | | defined in | | |
| | | | | subclause 11.2.2 of | | |
| | | | | TS 38.331, if the | | |
| | | | | target NG-RAN | | |
| | | | | node is a gNB. | | |
| >Location Reporting | O | | 9.2.3.47 | Includes the | — | |
| Information | | | | necessary | | |
| | | | | parameters for | | |
| | | | | location reporting. | | |
| >Mobility Restriction List | O | | 9.2.3.53 | | — | |
| >5GC Mobility Restriction | O | | 9.2.3.100 | | YES | ignore |
| List Container | | | | | | |
| >NR UE Sidelink Aggregate | O | | 9.2.3.107 | This IE applies only | YES | ignore |
| Maximum Bit Rate | | | | if the UE is | | |
| | | | | authorized for NR | | |
| | | | | V2X services. | | |
| >LTE UE Sidelink | O | | 9.2.3.108 | This IE applies only | YES | ignore |
| Aggregate Maximum Bit | | | | if the UE is | | |
| Rate | | | | authorized for LTE | | |
| | | | | V2X services. | | |
| >Management Based MDT | O | | MDT PLMN | | YES | ignore |
| PLMN List | | | List | | | |
| | | | 9.2.3.133 | | | |
| >UE Radio Capability ID | O | | 9.2.3.138 | | YES | reject |
| >MBS Session Information | O | | 9.2.1.36 | | YES | ignore |
| List | | | | | | |
| >5G ProSe UE PC5 | O | | NR UE | This IE applies only | YES | ignore |
| Aggregate Maximum Bit | | | Sidelink | if the UE is | | |
| Rate | | | Aggregate | authorized for 5G | | |
| | | | | ProSe services. | | |
| | | | Maximum Bit | | | |
| | | | Rate | | | |
| | | | 9.2.3.107 | | | |
| >UE Slice Maximum Bit | O | | 9.2.3.167 | | YES | ignore |
| Rate List | | | | | | |
| Trace Activation | O | | 9.2.3.55 | | YES | ignore |
| Masked IMEISV | O | | 9.2.3.32 | | YES | ignore |
| UE History Information | M | | 9.2.3.64 | | YES | ignore |
| UE Context Reference at | O | | | | YES | ignore |
| the S-NG-RAN node | | | | | | |
| >Global NG-RAN Node ID | M | | 9.2.2.3 | | — | |
| >S-NG-RAN node UE | M | | NG-RAN | | — | |
| XnAP ID | | | node UE | | | |
| | | | XnAP ID | | | |
| | | | 9.2.3.16 | | | |
| Conditional Handover | O | | | | YES | reject |
| Information Request | | | | | | |
| >CHO Trigger | M | | ENUMERATED | | — | |
| | | | (CHO- | | | |
| | | | initiation, | | | |
| | | | CHO- | | | |
| | | | replace, ...) | | | |
| >Target NG-RAN node UE | C- | | NG-RAN | Allocated at the | — | |
| XnAP ID | ifCHOmod | | node UE | target NG-RAN | | |
| | | | XnAP ID | node | | |
| | | | 9.2.3.16 | | | |
| >Estimated Arrival | O | | INTEGER | | — | |
| Probability | | | (1..100) | | | |
| NR V2X Services Authorized | O | | 9.2.3.105 | | YES | ignore |
| LTE V2X Services | O | | 9.2.3.106 | | YES | ignore |
| Authorized | | | | | | |
| PC5 QoS Parameters | O | | 9.2.3.109 | This IE applies only | YES | ignore |
| | | | | if the UE is | | |
| | | | | authorized for NR | | |
| | | | | V2X services. | | |
| Mobility Information | O | | BIT STRING | Information related | YES | ignore |
| | | | (SIZE (32)) | to the handover; | | |
| | | | | the source NG- | | |
| | | | | RAN node provides | | |
| | | | | it in order to enable | | |
| | | | | later analysis of the | | |
| | | | | conditions that led | | |
| | | | | to a wrong HO. | | |
| UE History Information from | O | | 9.2.3.110 | | YES | ignore |
| the UE | | | | | | |
| IAB Node Indication | O | | ENUMERATED | | YES | reject |
| | | | (true, ...) | | | |
| No PDU Session Indication | O | | ENUMERATED | This IE applies only | YES | ignore |
| | | | (true, ...) | if the UE is an IAB- | | |
| | | | | MT. | | |
| Time Synchronisation | O | | 9.2.3.153 | | YES | ignore |
| Assistance Information | | | | | | |
| QMC Configuration | O | | 9.2.3.156 | | YES | ignore |
| Information | | | | | | |
| 5G ProSe Authorized | O | | 9.2.3.159 | | YES | ignore |
| 5G ProSe PC5 QoS | O | | 9.2.3.160 | This IE applies only | YES | ignore |
| Parameters | | | | if the UE is | | |
| | | | | authorized for 5G | | |
| | | | | ProSe services. | | |
| Cell Trajectory Prediction | O | | 9.2.3.x | | YES | ignore |

| Condition | Explanation |
|---|---|
| ifCHOmod | This IE shall be present if the CHO Trigger IE |
| | is present and set to “CHO-replace”. |

| Range bound | Explanation |
|---|---|
| maxnoofMDTPLMNs | PLMNs in the Management Based MDT PLMN |
| | list. Value is 16. |

### End of 2^{nd} Change

——TEXT OMITTED——

### 3^{rd} Change

### 9.2.3.x Cell Trajectory Prediction

The Cell Trajectory Prediction IE contains the list of predicted NR cells the UE will move to after being handed over from the source NG-RAN Node.

| | | | IE Type and | |
|---|---|---|---|---|
| IE/Group Name | Presence | Range | Reference | Semantics Description |
| Predicted Trajectory | | 1 . . . | | List of cells where the UE is |
| Cell List | | <maxnoofCellsTrajectoryPredict> | | predicted to connect, in |
| | | | | chronological order. The |
| | | | | first predicted cell that the |
| | | | | UE will move to after the |
| | | | | serving cell is added to the |
| | | | | top of this list |
| >Predicted Trajectory | M | | 9.2.3.y | |
| Cell Information | | | | |

| Range bound | Explanation |
|---|---|
| maxnoofCellsTrajectoryPredict | Maximum number of cells that can be |
| | predicted for UE trajectory. Value is 8. |

### 9.2.3.y Predicted Trajectory Cell Information

The Predicted Trajectory Cell Information contains the cell ID of the predicted cell for trajectory prediction.

| | | | | |
|---|---|---|---|---|
| | | | IE type and | |
| IE/Group Name | Presence | Range | reference | Semantics description |

| | | | |
|---|---|---|---|
| CHOICE Predicted Trajectory | M | | |
| Cell Information | | | |
| >NG-RAN Cell | | | |
| >>Global NG-RAN Cell | M | 9.2.2.27 | |
| Identity | | | |
| >>Predicted Time UE | M | INTEGER (0 . . . 4095) | The duration of time the UE is |
| Stays in Cell | | | expected to stay in the cell, or |
| | | | set of NR cells with the same NR |
| | | | ARFCN for reference point A, in |
| | | | seconds. If the duration is more |
| | | | than 4095 s, this IE is set to |
| | | | 4095. |

### End of 3^{rd} Change

——TEXT OMITTED——

### 4^{th} Change

### 9.3.4 PDU Definitions

-- ASN1START

-- **************************************************************

--

-- PDU definitions for XnAP.

--

-- **************************************************************

XnAP-PDU-Contents {

itu-t (0) identified-organization (4) etsi (0) mobileDomain (0)
ngran-access (22) modules (3) xnap (2) version1 (1) xnap-PDU-Contents (1) }
DEFINITIONS AUTOMATIC TAGS ::=

BEGIN

-- **************************************************************

--

-- IE parameter types from other modules.

--

-- **************************************************************

IMPORTS

ActivationIDforCellActivation,

| | -- TEXT OMITTED - |
|---|---|
| SRB-ID, | |

CellTrajectoryPrediction

FROM XnAP-IEs

```
  PrivateIE-Container{ },
  ProtocolExtensionContainer{ },
  ProtocolIE-Container{ },
  ProtocolIE-ContainerList{ },
  ProtocolIE-ContainerPair{ },
  ProtocolIE-ContainerPairList{ },
  ProtocolIE-Single-Container{ },
  XNAP-PRIVATE-IES,
  XNAP-PROTOCOL-EXTENSION,
  XNAP-PROTOCOL-IES,
  XNAP-PROTOCOL-IES-PAIR
```

FROM XnAP-Containers

id-ActivatedServedCells,

-- TEXT OMITTED -

```
  id-F1-terminatingIAB-donorIndicator,
  id-CellTrajectoryPrediction,
  maxnoofCellsinNG-RANnode,
  maxnoofDRBS,
  maxnoofPDUSessions,
  maxnoofQoSFlows,
  maxnoofServedCellsIAB,
  maxnoofTrafficIndexEntries,
  maxnoofTLAsIAB,
  maxnoofBAPControlPDURLCCHs,
  maxnoofServingCells
```

FROM XnAP-Constants;

-- **************************************************************

--

-- HANDOVER REQUEST

--

-- **************************************************************
HandoverRequest ::= SEQUENCE {

| protocolIEs | ProtocolIE-Container | {{HandoverRequest-IEs}}, |
|---|---|---|
| ... | | |
| } | | |

HandoverRequest-IEs XNAP-PROTOCOL-IES ::= {

| { ID id-sourceNG-RANnodeUEXnAPID | | | | CRITICALITY reject TYPE NG-RANnodeUEXnAPID |
|---|---|---|---|---|
| | PRESENCE mandatory}\| | | | |
| { ID id-Cause | | | | CRITICALITY reject TYPE Cause |
| | PRESENCE mandatory}\| | | | |
| { ID id-targetCellGlobalID | | | | CRITICALITY reject TYPE Target-CGI |
| | PRESENCE mandatory}\| | | | |
| { ID id-GUAMI | | | | CRITICALITY reject TYPE GUAMI |
| | PRESENCE mandatory}\| | | | |
| { ID id-UEContextInfoHORequest | | | | CRITICALITY reject TYPE |
| UEContextInfoHORequest | | | PRESENCE mandatory} \| | |
| { ID id-TraceActivation | | | | CRITICALITY ignore TYPE TraceActivation |
| | PRESENCE optional }\| | | | |
| { ID id-MaskedIMEISV | | | | CRITICALITY ignore TYPE MaskedIMEISV |
| | PRESENCE optional }\| | | | |
| { ID id-UEHistoryInformation | | | | CRITICALITY ignore TYPE UEHistoryInformation |
| | PRESENCE mandatory}\| | | | |
| { ID id-UEContextRefAtSN-HORequest | | | | CRITICALITY ignore TYPE UEContextRefAtSN- |
| HORequest | PRESENCE optional }\| | | | |
| { ID id-CHOinformation-Req | | | | CRITICALITY reject TYPE CHOinformation-Req |
| | PRESENCE optional }\| | | | |
| { ID id-NRV2XServicesAuthorized | | | | CRITICALITY ignore TYPE |
| NRV2XServicesAuthorized | | PRESENCE optional }\| | | |
| { ID id-LTEV2XServicesAuthorized | | | | CRITICALITY ignore TYPE |
| LTEV2XServicesAuthorized | | | PRESENCE optional }\| | |
| { ID id-PC5QoSParameters | | | | CRITICALITY ignore TYPE PC5QoSParameters |
| | PRESENCE optional }\| | | | |
| { ID id-MobilityInformation | | | | CRITICALITY ignore TYPE MobilityInformation |
| | PRESENCE optional }\| | | | |
| { ID id-UEHistoryInformationFromTheUE | | | | CRITICALITY ignore TYPE |
| UEHistoryInformationFromTheUE | | PRESENCE optional }\| | | |
| { ID id-IABNodeIndication | | | | CRITICALITY reject TYPE IABNodeIndication |
| | PRESENCE optional }\| | | | |
| { ID id-NoPDUSessionIndication | | | | CRITICALITY ignore TYPE |
| NoPDUSessionIndication | | | PRESENCE optional }\| | |
| { ID id-TimeSynchronizationAssistanceInformation | | | | CRITICALITY ignore TYPE |
| TimeSynchronizationAssistanceInformation | | | | PRESENCE optional }\| |
| { ID id-QMCConfigInfo | | | | CRITICALITY ignore TYPE QMCConfigInfo |
| | PRESENCE optional }\| | | | |
| { ID id-FiveGProSeAuthorized | | | | CRITICALITY ignore TYPE FiveGProSeAuthorized |
| | PRESENCE optional }\| | | | |
| { ID id-FiveGProSePC5QoSParameters | | | | CRITICALITY ignore TYPE |
| FiveGProSePC5QoSParameters | | PRESENCE optional }\| | | |
| { ID id-CellTrajectoryPrediction | | | | CRITICALITY ignore TYPE |
| CellTrajectoryPrediction | | | PRESENCE optional }, | |
| ... | | | | |
| } | | | | |

-- TEXT OMITTED -

### 9.3.5 Information Element Definitions

| | -- TEXT OMITTED - |
|---|---|
| maxnoofSMBR, | |

maxnoofCellsTrajectoryPredict

-- TEXT OMITTED -

CellToReport ::= SEQUENCE (SIZE (1..maxnoofCellsinNG-RANnode)) OF CellToReport-Item
CellToReport-Item ::= SEQUENCE {

| cell-ID | | GlobalNG-RANCell-ID, | |
|---|---|---|---|
| sSBToReport-List | | SSBToReport-List | OPTIONAL, |
| sliceToReport-List | | SliceToReport-List | OPTIONAL, |
| iE-Extensions | ProtocolExtensionContainer { { CellToReport-Item- | | |
| ExtIEs} } OPTIONAL, | | | |
| ... | | | |
| } | | | |

CellToReport-Item-ExtIEs XNAP-PROTOCOL-EXTENSION ::= {

...
}

CellTrajectoryPrediction ::= SEQUENCE (SIZE (1..maxnoofCellsTrajectoryPredict)) OF
CellTrajectoryPrediction-Item
CellTrajectoryPrediction-Item ::= CHOICE {

| nG-RAN-Cell-Predicted | PredictedTrajectoryNGRANCellInfo, |
|---|---|
| choice-extension | ProtocolIE-Single-Container { { CellTrajectoryPrediction- |
| Item-ExtIEs} } | |
| } | |

CellTrajectoryPrediction-Item-ExtIEs XNAP-PROTOCOL-IES ::= {

...
}

Cell-Type-Choice ::= CHOICE {

| ng-ran-e-utra | E-UTRA-Cell-Identity, |
|---|---|
| ng-ran-nr | NR-Cell-Identity, |
| e-utran | E-UTRA-Cell-Identity, |
| choice-extension | ProtocolIE-Single-Container { { Cell-Type-Choice-ExtIEs} } |
| } | |

Cell-Type-Choice-ExtIEs XNAP-PROTOCOL-IES ::= {
...

}

-- TEXT OMITTED -

PortNumber ::= BIT STRING (SIZE (16))
PredictedTrajectoryNGRANCellInfo ::= SEQUENCE {

| | |
|---|---|
| globalNG-RANCell-ID | GlobalNG-RANCell-ID, |
| predictedTimeUEStaysInCell | INTEGER (0..4095) |
| iE-Extensions | ProtocolExtensionContainer |

{ { PredictedTrajectoryNGRANCellInfo-ExtIEs} } OPTIONAL,

...
}

PredictedTrajectoryNGRANCellInfo-ExtIEs XNAP-PROTOCOL-EXTENSION ::= {

...
}

PriorityLevelQoS ::= INTEGER (1..127, ...)

-- TEXT OMITTED -

### 9.3.7 Constant Definitions

-- TEXT OMITTED -

-- **************************************************************

--
-- Lists
--

-- **************************************************************

| | | |
|---|---|---|
| | -- TEXT OMITTED - | |
| maxnoofSMBR | | INTEGER ::= 8 |
| maxnoofCellsTrajectoryPredict | | INTEGER ::= 8 |

-- **************************************************************

--
-- IEs
--

-- **************************************************************

| | -- TEXT OMITTED - |
|---|---|
| id-F1-terminatingIAB-donorIndicator | |
| ProtocolIE-ID ::= 363 | |
| id-CellTrajectoryPrediction | |
| ProtocolIE-ID ::= xxx | |

End of Changes

1. A method performed by a first network node, the method comprising:
obtaining a user equipment, UE, trajectory prediction;
transmitting to a second network node the UE trajectory prediction and an indication requesting feedback regarding the UE trajectory prediction, wherein the indication requesting feedback comprises assistance information for associating an identifier with the requested feedback; and
receiving feedback regarding the UE trajectory prediction from a third network node based on the transmitted assistance information.

2. The method of claim 1, wherein the second network node and the third network node are the same network node.

3. The method of claim 1, wherein the assistance information comprises an identifier for associating the requested feedback with the UE trajectory prediction.

4. The method of claim 3, wherein the identifier comprises an identifier of a UE.

5. The method of claim 3, wherein the received feedback includes the identifier for associating the requested feedback with the UE trajectory prediction.

6. The method of claim 1, wherein the assistance information comprises an identifier of a network node for receiving the feedback.

7. The method of claim 1, wherein receiving the feedback comprises receiving an artificial intelligence/machine learning assistance data update message.

8. The method of claim 1, wherein the assistance information comprises an indication that feedback is requested after a threshold number of handovers.

9. The method of claim 1, wherein the received feedback comprises a list of UE trajectory cells.

10. The method of claim 1, wherein the received feedback comprises a dwelling time for each cell of a list of UE trajectory cells.

11. The method of claim 1, further comprising training an artificial intelligence or machine learning model with the received feedback.

12. A first network node comprising processing circuitry operable to:
obtain a user equipment, UE, trajectory prediction;
transmit to a second network node the UE trajectory prediction and an indication requesting feedback regarding the UE trajectory prediction, wherein the indication requesting feedback comprises assistance information for associating an identifier with the requested feedback; and
receive feedback regarding the UE trajectory prediction from a third network node based on the transmitted assistance information.

13. (canceled)

14. A method performed by a second network node, the method comprising:
receiving a user equipment, UE, trajectory prediction and an indication requesting feedback regarding the UE trajectory prediction, wherein the indication requesting feedback comprises assistance information for associating an identifier with the requested feedback; and
transmitting feedback regarding the UE trajectory prediction to a first network node based on the assistance information.

15. The method of claim 14, wherein the first network node comprises a radio access network, RAN, node or an operations and management, OAM, node.

16. The method of claim 14, wherein the assistance information comprises an identifier for associating the requested feedback with the UE trajectory prediction.

17. The method of claim 16, wherein the identifier comprises an identifier of a UE.

18. The method of claim 16, wherein the transmitted feedback includes the identifier for associating the requested feedback with the UE trajectory prediction.

19. The method of claim 14, wherein the assistance information comprises an identifier of a network node for transmitting the feedback.

20. The method of claim 14, wherein transmitting the feedback comprises transmitting an artificial intelligence/machine learning assistance data update message.

21. The method of claim 14, wherein the assistance information comprises an indication that feedback is requested after a threshold number of handovers.

22. The method of claim 14, wherein the transmitted feedback comprises a list of UE trajectory cells.

23. The method of claim 14, wherein the transmitted feedback comprises a dwelling time for each cell of a list of UE trajectory cells.

24. A second network node comprising processing circuitry operable to:
receive a user equipment, UE, trajectory prediction along with an indication requesting feedback regarding the UE trajectory prediction; and
transmit feedback regarding the UE trajectory prediction to a first network node.

25. (canceled)
